(19) United States
(12) Patent Application Publication
(10) Pub. No.: US 2018/0012455 A1
(43) Pub. Date: Jan. 11, 2018

(54) CARD AND DICE GAMES

(71) Applicant: Xari Gaming, LLC, Las Vegas, NV (US)

(72) Inventor: Peter Costa, Las Vegas, NV (US)

(21) Appl. No.: 15/645,536

(22) Filed: Jul. 10, 2017

Related U.S. Application Data
(60) Provisional application No. 62/359,821, filed on Jul. 8, 2016.
(60) Provisional application No. 62/411,016, filed on Oct. 21, 2016.
(60) Provisional application No. 62/468,682, filed on Mar. 8, 2017.

(51) Int. Cl. G07F 17/32

(52) U.S. Cl. CPC G07F 17/3293; G07F 17/3288; G07F 17/3258; G07F 17/3276

(57) ABSTRACT

Disclosed are card games that can use a traditional deck or a custom card deck and that can be played in person or on an electronic gaming machine. The custom card deck disclosed herein is made up of 48 cards. There are two suits and eight sets of six cards numbered ace through six. The card deck can be used for unique games or for games that typically use dice. Example games that can be played with this deck are provided. Additionally, the disclosure describes various rules for standard play or tournament play that can be used for at least some of the disclosed games.

### CROSS-REFERENCE TO RELATED APPLICATION

This application claims the benefit of U.S. Provisional Application No. 62/359,821, filed Jul. 8, 2016 and titled CARD AND DICE GAMES, and of U.S. Provisional Application No. 62/411,016, filed Oct. 21, 2016 and titled CARD GAMES, and is a continuation-in-part of U.S. application Ser. No. 14/789,982, filed Jul. 1, 2015 and titled CARD DECK AND GAMES.

### BACKGROUND

Card games are typically played using a 52-card deck of playing cards. These cards are often made of a heavy glossy paper or plastic material. The front surface of the card includes printed indicia thereon that distinguish the cards from each other. The rear surfaces of the cards are blank or include a decorative design or pattern. The rear surface is typically the same on all cards so that one card cannot be distinguished form another card by viewing the rear surface. Various card games can be played using this standard deck of cards. Card games are often now played in an electronic format online or utilizing an electronic gaming cabinet or video poker type machine.

A variety of different card games exist. Some card games involve gambling. An example of a gambling card game is blackjack, in which players bet into a pool, called the pot. Each player receives two cards with the option to receive one or more cards. After betting has been completed, players compare their hands with each other to determine the winner. The pot is awarded to the winner.

Dice games are typically played using two or more dice. These dice are often made of a plastic material and are six-sided cubes. Each side of the dice is labeled with a number (one, two, three, four, five, or six) with each number being represented once per die. A variety of difference dice games exist. Some dice games involve gambling. An example of a dice game is backgammon.

### SUMMARY OF INVENTION

Generally, the disclosed invention is related to games that can use a traditional deck, in some embodiments, a custom card deck, or no deck of cards. Additionally, the disclosure describes various tournament rules that can be used for some of the disclosed games.

### BRIEF DESCRIPTION OF THE DRAWINGS

FIG. 1 illustrates an example deck of playing cards.

FIG. 2 illustrates several playing cards arranged on a table during play.

FIG. 3A is a schematic block diagram depicting an example computing system used in accordance with one embodiment of the present invention.

FIG. 3B is a schematic block diagram depicting an example computing system used in accordance with one embodiment of the present invention.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

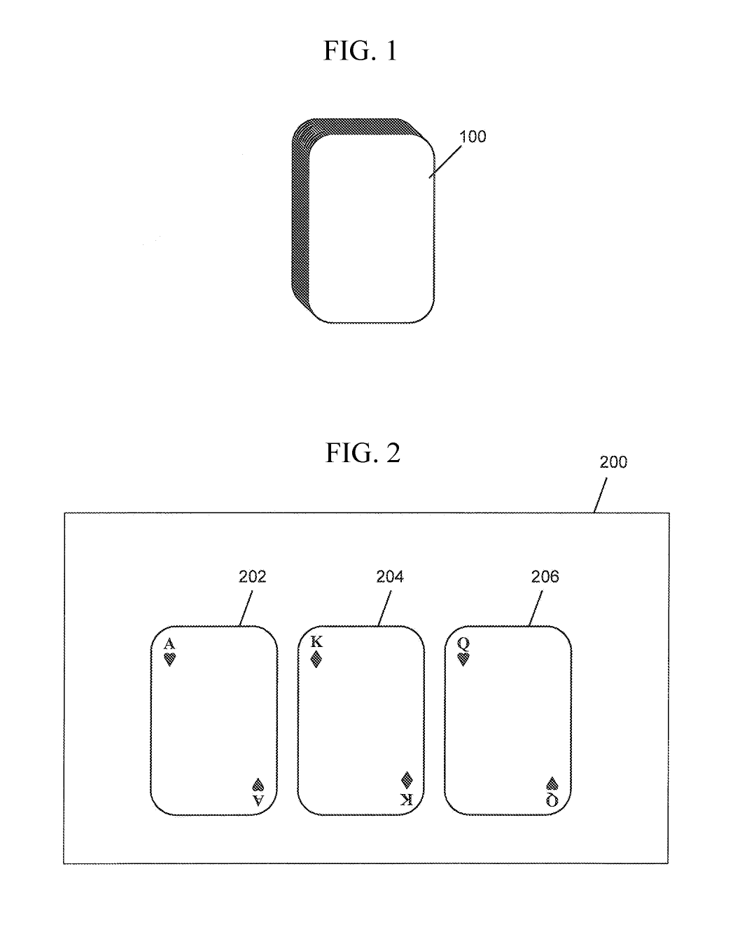

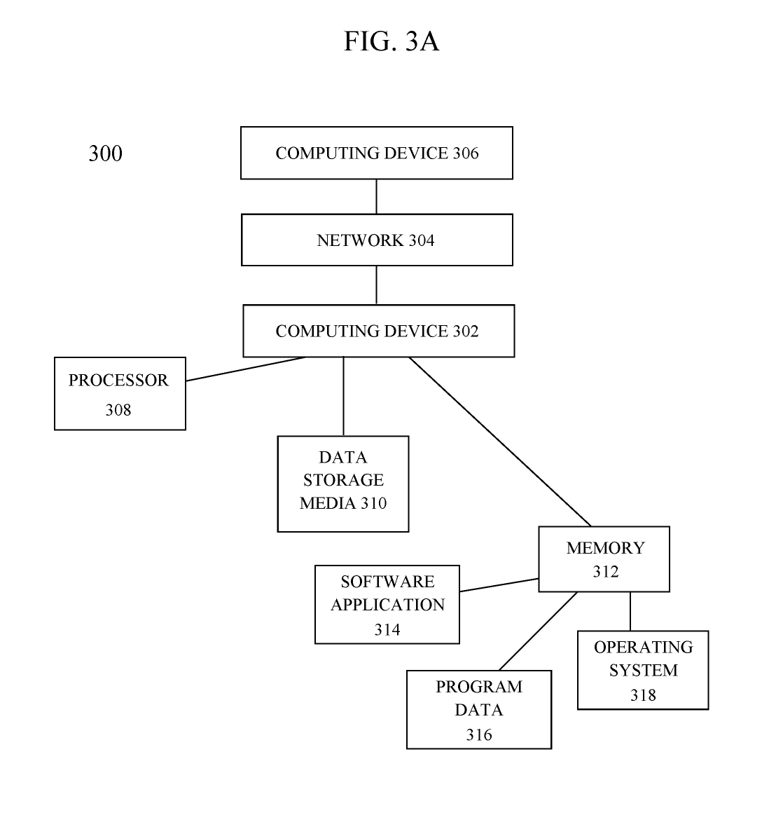

FIG. 1 illustrates an example deck of playing cards 100. A standard 52-card deck of playing cards 100 can be used in some embodiments. In other embodiments, a deck of dice whereas there are six cards in a set (from ace through to six), two colors and two suits and with 8 sets forming a deck of 48 cards. FIG. 2 shows some of playing cards 100 (202, 204 and 206) arranged on a table 200.

In some embodiments, playing cards 100 are made of paper, such as a heavy paper, thin card, or thin plastic, or may be electronically represented on a screen as though they were physical playing cards as described herein. Playing cards 100 typically include a face surface and a back surface. The face surface typically includes markings thereon that distinguish the cards from other cards in the deck. The markings are also used to determine the permissible uses of each card according to the rules of the game being played, such as discussed in more detail herein. Examples of markings include printed indicia that identify the card as being one of an Ace, 2, 3, 4, 5, 6, 7, 8, 9 10, Jack, Queen, and King, and also identify the card as being of a suit selected from diamonds, clubs, hearts, and spaces, in some embodiments.

One-Card Poker

In one embodiment, a standard deck of 52 playing cards is used. The object is to offer a variety of wagering options based on the best five-card poker hand, from a total of seven cards. Six of these cards will come by way of a community board. From these six cards, four cards should be used to count towards the best five-card poker hand.

To complete the best five-card poker hand, one card from the thirteen different value cards will be used to determine the best five-card hand. The thirteen cards are Ace, King. Queen, Jack, Ten, Nine, Eight, Seven, Six, Five, Four, Three, and a Deuce. Each of these thirteen cards (known as the wagering cards) will be represented once for each of the four suites. The four suites are hearts, diamonds, clubs, and spades.

Therefore, irrespective of what the community board may be, one of the above named cards, along with four cards from the community flop, will be used to determine the best possible five-card poker hand.

In one example, the board is comprised of the following six cards, 2, 3, 4, 5, 6, and 7. In this case, the best card from the thirteen wagering cards would be an 8, making an 8-high straight comprising of 4, 5, 6, 7, 8. In any instance, when the community flop contains four or more cards of the same suit, the Ace (from the wagering cards), will be the card that completes the best five-card poker hand.

In the above example, if the 2, 3, 4, and 7 are of the same suite, then the Ace would be used to make an Ace-high flush. Continuing with the above example, if the 2, 3, 4, and 5 are of the same suit, then it would be a 6 from the wagering card that complete the best five-card poker hand by making a six-high straight flush.

Therefore, before the community board of six cards is dealt, players will wager on one or more of the thirteen wagering cards. The odds will vary for each wagering, with Ace offering the least odds and a Deuce offering the highest odds. For example, an Ace would offer odds of 8-1, while the Deuce would offer odds of 100-1. The odds for each of the thirteen wagering cards will be determined by the final math.

Only one wagering card would win except in a rare situation when an Ace-high straight is dealt on the board. For example, when a Ten, Jack, Queen, King, and Ace form five of the six community cards. In this case, all wagers on any of those five cards would win.

Other Wagering Options

1. Six card poker. A pay table will be used to offer a variety of odds and wagers based on the six community cards

2. Seven card poker. A pay table will be used to offer a variety of odds and wagers based on seven cards. The wagering card may or may not be included.

3. Exacta wagers. Exacta wagers will offer a variety of odds to predict the best two hands in correct order. For example, Ace-King exacta will require the Ace-wagering card to be the best card followed by the King. As an example, the community board contains the following six cards, 2, 3, 6, 7, A, K (with no possible flush), the Ace from the wagering cards would be used to form the winning hand, followed by the King as the next best hand. If four of the above cards are of the same suit, the exacta wager will win, but only if Ace or King were not part of the four suited cards.

4. A Trifecta (the best three hands) will require Ace, King, and Queen to form the best three hands in that order. For example, the community board contains the following six cards, 2, 3, 6, A, K, and Q. In this case, the Trifecta wager would win.

The odds on all wagers will be determined by the final math.

Further Wagering Options

The overall aim is to create a form of poker roulette by including a variety of wagering groups. For example, wagering cards to be split into two groups and offering even money payouts. The number of wagering cards in each may differ. To create a house edge, one of the thirteen wagering cards will be excluded. For example, Group (a) may include a 2, 3, 4, 5, 6, 7, 8, and 9 and group (b) may include J, Q, K, and A. In this example, the “Ten” would be the house card—like the zero in roulette. These examples may differ and cards may not run in sequence in order to create the two groups and a house card.

For example, the Ten may create too big of a house edge, and a different value card may be required. The same applies to the two groups, and the math may dictate that a mixture of wagering cards will be required to form two identical even money groups. It could very well be the case that the math will not allow for two even money groups.

What the math will allow is for three and four groups. For example, if there are three groups, each group will contain four wagering cards, with each group paying varying odds. Again, one of the 13 wagering cards may be excluded to create a house edge. It could also be the case that a house card will not be required, and a house edge is created from the total possible payouts. In this case, all thirteen wagering cards will be included.

For example: Group (a) 2, 3, 4, 5, and 6. Group (b) 7, 8, 9, and 10. Group (c) J, Q, K, and A.

Example Group Odds: Group (a) 5-2. Group (b) 2-1. Group (c) 3-2.

Again, the math may dedicate the need to mix the selection of wagering cards to create the three groups. Odds may also vary. The same principle is applied to form four groups.

Pay Table Wagers

This wager is an expansion to the field bet in craps and would include and exclude cards accordingly to create a pay table based on the winning wagering card.

An example payout is as follows: 1-1; 2-1; 3-1; 5-1; 10-1; and 20-1.

The wagering cards for each would be dependent on the final but as an example:

Ace—1-1

Queen—1-1

Ten—1-1

Eight—3-1

Four—4-1

Deuce—5-1

All others lose.

Top Trio (if Math Allows)

This would comprise of a wager on any of the top three cards Ace, King, or Queen, winning. In some embodiments, there could be a 3-2 payout.

Top Two

(Ace-King)

Wagering Options Summary

13 wagering cards

2 groups paying 1-1 (if possible and perhaps)

4 groups paying variable odds—a must if possible

Pay Tables with two groups (field bet) at least one and perhaps two

Top Trio or Top Two—a must to include one and, in some embodiments, both

Top Two exacta A-K (Ace to be the best hand and king and second best hand)—to include if possible

One-Card Poker (Skill Version)

The object is to create a five-card poker hand by using a community board of six cards and a player's and a dealer's one card. Players place an ante and are dealt one card face down. The dealer is dealt one card face up. Players then have the option to either raise or fold. Once all players have acted, the dealer will then be dealt a second card face-up. The dealer may use either of the two cards to create the best five-card hand. Without the dealer's second card, players would have an advantage. It is also expected that a dealer having two cards would create too big of a house edge.

The following three options may allow the math to work.

1. Pay 3-2 to winning players.

2. Players win all ties.

3. Pay 3-2 or 2-1 to players when the player's card is lower than both dealer cards

A bonus pay table wager may be offered for a five, six, or seven-card poker hand. The initial ante and raise option could introduce a third option by way of a call. For example, a call must be equal value to the ante and a raise by two the ante. A progressive jackpot could be offered either with a wagering card in play or without

Two-Card War

Players place an ante and are then dealt two cards face up. The dealer is dealt one card face up and one card face down. Based on the dealer's exposed card, players must determine if the wish to continue in the hand by making a further wager or forfeit the ante. Depending on the math of the game, the second wager maybe equal or more than the ante.

The object of the game is for the player to beat the two dealer's two cards in order to win the wager. In effect, it is two races with the player's highest card racing against the dealer's highest and the players other card racing against the dealers other card.

If either the dealer or the player fails to win both races then it is a tie, with neither winning nor losing. In a race situation when the dealer's card is the same as the player's card, then the dealer is deemed to have won that particular race. In effect, the dealer wins all ties.

There is flexibility within the math to offer a bonus payout to players, for example, 3-2 for winning with A-K and 3-1 for winning with A-A. Another possible bonus payout could apply if a player's two card match the dealers two cards. This may encourage the player to continue with the second wager if matching the dealers open card with one the players two cards.

A fast-paced and exciting game offering simple player calculation. A non-skill version would be for players to make a single wager that would eliminate the need to forfeit. A progressive jackpot could be offered for a player and dealer matching the same pair.

Crazy Colors

Players place an enforced wager and are dealt two cards face up—one at a time and placed in order they were dealt. A player will win 1 for 1 if the two cards are of different color—one red and one black. If both cards are the same color, the player loses.

When the player wins, the player has the option to let the wager ride and be dealt another card. The player will win 1-1 if that card is the opposite color to the preceding card. For example, if the player's first two cards were red and then black, the next card must be red in order to win. If black, the player losses.

If the card is red and the player wins, the player has the same option to take the winnings or let it ride. If player wishes to let it ride, the next card must be black for the wager to win. In effect, a winning sequence would be red, black, red, black, red, black and so on until the player takes the winnings or loses. A $10 wager would therefore double to $20, then $40, then $80 and so on.

All-The-Way Side Wager

This is placed prior to any cards being dealt and will pay a variety of odds based on the number of winning hands. In this case, a winning hand will consist of two card, two winning hands will consist of three card, and so on.

This wager will play out irrespective if the player takes the winnings from the main wager and will continue until it loses or it has reached a maximum number of winning hands. In this example, the maximum is set at eleven winning hands though this number maybe higher or lower—depending on the math.

Example Pay Table

4 winning hands will pay 2-1

5 winning hands will pay 4-1

6 winning hands will pay 6-1

7 winning hands will pay 8-1

8 winning hands will pay 12-1

9 winning hands will pay 25-1

10 winning hands will pay 50-1

11 winning hands will pay 100-1

A further optional wager would be for a progressive jackpot. Again, the math will determine the number of winning hands required to win the jackpot.

House Edge

A house edge is created when a player loses the wager because the last two cards in sequence form a pair—irrespective of the color. This creates an estimated house edge of 4%. In some embodiments, the player's losses can be reduced if the player forms a pair from an opposite color, therefore losing only 50% of the wager. A pair of the same color would lose 100% of the wager.

Another option to decrease house edge is to pay 2-1 or 3-1 when dealt A-A or K-K and even perhaps Q-Q on the first two cards. This adds extra excitement to the first two cards of the game.

Custom Deck Games

The custom deck is comprised of forty-eight cards broken down into eight sets of six, with a value of one through to six. In effect it is a deck of dice. It is split into two colors and two suites. For example, the two colors may be red and black, and the two suites may be circles and squares. The color design may differ, as may the two suites.

Blackjack 11

This game can be dealt in the same format as standard blackjack, but played to 11 rather than 21. The game can offer a variety of extra wagers including a two-card pay table based on points scored and suites. In some embodiments, the dealer must draw to up to eight and stay on nine.

Players tend to have simpler decisions, as eight is the one points score requiring a major decision—any other score is dictated by the odds. Example, with a score of seven, a player has four cards that are beneficial and only two cards to bust. On a core of nine, a player has only two cards that are beneficial and four cards that bust.

The math allows for a player blackjack with 6-5, while dealer blackjack is eradicated with a dealer 6-5 counting simply as eleven. A 6-6 for the player is either a push or a split and not a bust hand. It offers a progressive Jackpot for five Aces of the same suit and a secondary jackpot for any five Aces.

In some embodiments, a dealer pushes all wagers on 6-6 and A-A. Therefore, “dealer push insurance” is offered when the dealer's face up card is an Ace or a Six, wherein the insurance pays 9-2. Despite the variety of optional wagers, Blackjack 11 is more engaging as a game, while at the same retaining the simplicity that is the trademark of blackjack.

Math

Dealer stands on a total of *9* or higher

Dealer does not take a hole card

Player initial hand of 6-6 pushes unless player splits

Player initial hand of 6-5 automatically wins

Dealer final hand of 6-6 pushes all non-busted hands

Dealer final hand of A-A pushes all non-busted hands

Player may split any pair, but only receives one card on a split pair of 6s

Player may double down on any two-card total, even after splitting

Note: A five card unbusted hand automatically proved too strong, and eliminated the house edge entirely.

The two different variants are:

All player winners on 6-5 pay 3:2=2.75% house edge

6-5 pays 3:2 if different suits, 2:1 if suited=1.22% house edge

Player total-dependent optimal strategy is: Stand on nine or more, with a couple of rare, complex exceptions for multicard eights against an Ace or Deuce. Split 4-4, 6-6 against any upcard. Double on a total of five against an Ace.

Points+ (Actual Math and Based on the Players First Two Cards)

Suited 6-6=15:1

Offsuit 6-6=8:1

Suited 5-6=4:1

Offsuit 5-6=2:1

Any 10=3:2

Any other straight flush=1:1

All others lose

House edge 4.43%

EZ 3 Poker

The object of the game is to have a higher-ranked hand than the dealer, where hands are ranked as follows from best to worst: Suited 3 of a Kind (Sixes highest, Aces lowest); Unsuited 3 of a Kind; Straight Flush (456 high, A23 low); Unsuited Straight; Flush with Pair (665 high, then 664, 663, 662, 661, 556, 554, . . . , 112 low); Flush (suited 356 high, then 256, 156, 346, 246, 146, 236, . . . , 124 low); High card (unsuited 356 high, . . . , 124 low). Players can make an “ante” bet after which players and dealer are each dealt three cards. Players may then choose to fold and lose their ante, or make an additional “play” bet of the same size as the ante bet.

In some embodiments, the dealer needs a “qualifying hand” of 146 unsuited to play (in effect 6-4 high). If the dealer has one of the ten lowest ranked hands (unsuited 124, 134, 125, 135, 235, 145, 245, 126, 136, 236) then the player is paid even money on his ante bet and his play bet pushes, regardless of whether or not the player's hand is higher than the dealer's hand.

This game was analyzed using combinatorial mathematics. The optimal strategy for the player is to fold with unsuited 156 and lower and play with unsuited 256 and higher. With this strategy, the player folds 31.08% of the time, for an average wager of 1.69 units, and the House Edge (average player loss over all possible deals) is 3.53% of a unit bet.

Flush Plus is an optional wager placed prior to the cards being dealt and pays according to a pay table. This example pay table below may include other combinations and pay different payouts.

This game can be played with an optional side bet which pays based on the rank of the player's 3-card hand, independent of the dealer's hand. There are two possible pay tables:

Pay Table 1: Suited 3 of a kind 10:1, 3 of a kind 5:1, Straight Flush 4:1, Straight 2:1, Flush (including Pair Flush) 1:1, Unsuited Pair or High Card Loses. House Edge: 5.18%

Pay Table 2: Suited 3 of a kind 10:1, 3 of a kind 10:1, Straight Flush 3:1, Straight 3:2, Flush (including Pair Flush) 1:1, Unsuited Pair or High Card Loses. House Edge: 4.26%

A progressive jack could apply for a player to be dealt 6-6-6 of the same suit or more likely of a specific suit.

Further EZ 3 Poker Progressive options include (1) suited 3 of a kind tie occurs 1 time in 1,278,282/5 deals and (2) six of a kind (combining player and dealer hands) occurs 1 time in 73,044.7 deals.

Poker-Jack 11

A very fast-paced hybrid combining poker and blackjack to form a simple but addictive game. Players place equal wagers for both the blackjack and poker hands. Each hand is raced against the dealer. Player and dealer receive three cards from which the same two cards are used to form a blackjack hand closest to eleven and a two-card poker hand. Both player and dealer are deemed to bust when not able for form a blackjack hand of eleven or less by using their two cards.

The dealer must prioritize the best blackjack score but only if able to reach a certain total. Depending on the math, this benchmark will probably be a points score of seven or eight. If unable reach that score, the dealer, in some embodiments, must then create the best two-card poker hand.

An optional wager can be offered to players that utilize all three cards to form a three-card poker hand, which can pay according to the Flush+ pay table described herein.

In some embodiments, the house edge may be too low as there is only one combination for a player to “bust”—6-6-6. To increase this edge, a dealer may push all wagers when the dealer is dealt 6-6-6 and A-A-A. This could be expanded further to include 3-3-3 and 2-2-2 and perhaps also 4-4-4. The dealer being dealt 5-5-5 is a strong hand as it scores a total of ten with a pair of fives.

A progressive jackpot could apply when players is dealt 6-6-6 of the same suit or 6-6-6 or more likely of a specific suit.

Flush+Side Wager (Actual Math)

Trips—10:1

Straight flush—3:1

Straight—3:2

Flush—1:1

All others lose

Suited trips may also be added and different payouts may apply.

For example:

Suited trips 20:1

Trips—8:1

Straight flush—3:1

Straight—3:2

Flush—1:1

All others lose

A progressive jackpot could apply when both player and dealer tie with a 6-5 suited and of the same suit or when a player busts with 6-6-6 of the same suit. Math is required to determine if these are viable as the odds may be too low. For example the odds on being dealt 6-6-6 of the same suit are roughly about 2000-1.

Joker Poker 3

This is another game played with 3-card hands, but players and dealer are assumed to each have a “Joker” in their hand, which can substitute for any card and combine with their three-card hand to make the best possible 4-card hand.

Players make an ante wager and are then dealt two cards, while the dealer gets one card face up. Players may then choose to fold, losing their ante, or play, making an additional wager of the same size as the ante. Players are dealt a third card and the dealer gets two more cards. The player and dealer 4-card hands (formed by adding a fictitious “joker” to each hand) are ranked as follows: Suited 4 of a kind, Royal Flush, unsuited 4 of a Kind, Straight Flush, Suited 3 of a kind, Flush, Unsuited Straight, Unsuited 3 of a kind, Unsuited pair (high card plus joker).

In some embodiments, the dealer needs a “qualifying hand” of 126 unsuited to play. If the dealer has one of the three lowest ranked hands (unsuited 125, 135, 145) then the player is paid even money on his ante bet and his play bet pushes, whether or not the player's hand is higher than the dealer's hand.

This game was analyzed by using a computer program to generate all possible 6-card deals and calculate the best strategy for the player in each situation. The optimal strategy for the player involves folding in the following situations:

Unsuited 11, 12, or 13 against dealer 3 or 4

Unsuited 14 against dealer 4

Unsuited 15 always

Unsuited 16 or 26 against dealer 2, 3, 4, 5, 6

With this strategy, the player folds 10.42% of the time, for an average wager of 1.90 units, and the House Edge (average player loss over all possible deals) is 2.85% of a unit bet.

This game can be played with an optional side bet which pays based on the rank of the player's 2-card hand, independent of the dealer's hand. There are four pay tables (payouts “to 1”), as shown in Table 1.

Joker Poker Progressive: Double Quads tie occurs 1 time in 73,044.7 deals.

Bacca Poker

This game is a hybrid game combining baccarat and poker. Players can place two equal wagers, one for baccarat and one for poker. These are both raced against the dealer. Player and dealer are dealt three cards from which two of the three (same two) will be used to create a score closest to nine for baccarat as well as the best two-card poker hand.

A bust occurs when a player or dealer cannot score nine or under from any two-card combination. This creates a house edge of 2.31%, as there are five such combinations from a possible 216. This can be reduced by offering a blackjack-type payout of 3-2 for a specific hand, such as 5-4 suited.

Hand rankings for two-card poker are Straight flush; Pair; Straight; Flush; High card. Straights and flushes maybe allocated the same value with high card counting.

Flush+Side Bet (Actual Math)

Trips—10:1

Straight Flush—3:1

Straight—3:2

Flush—1:1

All others lose

Suited trips should also be added to the pay table and pay highest odds.

In some embodiments, a dealer must prioritize the dealer's baccarat score before the dealer's poker hand. A threshold maybe introduced, wherein the dealer would prioritize the poker hand if not reaching a set minimum baccarat score. Depending on the math, this could be six, seven, or eight.

A progressive jackpot could apply when players is dealt 6-6-6 of the same suit or more likely 6-6-6 of a specific suit.

Hi or Low (Twister)

Version One—Casino Version (Single or Multi Player)

In one embodiment, players place a wager and the players and the dealer are each dealt one card face up. The process is repeated with the highest card first to receive the second card. If the dealer is dealt the highest card, the dealer will play first and receive a second card.

If the dealer card is highest, but is matched by any of the players seated in the game, the player will receive the second card first, and the game will continue in a clockwise direction until all the players have received a second card.

To remain in the game, a player's second card must be higher or lower depending on the value of their first card. If a player's first card is a six, five, or four, the second card must be lower in order for the player to remain in the game. If it is higher or if it forms a pair, the player loses. If a player's first card is and Ace, two, or three, the second card must be higher in order for the player to remain in the game. If it is lower or forms a pair, the player loses and is eliminated.

In effect, whatever the player's card, the odds would be in favor of the player remaining in the game. It's simply a case of how high those odds would be. At worst and with the bust rule in place, it will be 50-50 as three cards favor and three cards bust. At best, four cards favor and only two cards bust.

In the case of the dealer, the same rules apply. If the dealer's second card is not higher or lower according to the first card, or if it forms a pair, the dealer busts and all players in the game are paid 1 for 1. The game continues in this fashion until either all players or the dealer has bust.

In order to introduce decision making into the game, players could ante then be offered the option to play. It will, in effect, be compulsory to play, as at worst, it will be 50-50 for the player to bust.

Math and House Edge

It's a disadvantage to play first and an advantage to play last. Therefore, if the dealer always played last as in blackjack, the house edge would certainly be too high. A house edge is, however, created due to the dealer not playing first when sharing the highest card.

With playing before the dealer being a disadvantage, seating order may be impacted. For example, in a multi-player game, players may prefer seat six rather than seat one. Enforcing such a rule, as explained above, also creates too big a house edge. One solution is to enforce this rule but to introduce a counter-balance. The counter-balance can be a further rule that is beneficial to players. The rule would be that a “pair” on the first two cards by a player would be a winner.

Depending on the math, the pair may have to be suited/same color in order for the player to remain in the game. Depending on the math, an unsuited pair may or may not be a bust or a player may lose 50% of the stake and may or may not be bust. Therefore, after the first two cards have been dealt, the game reverts to the rules stated above, whereas the highest card will play first and the game will continue in a clockwise direction.

The option for players to raise or double down may be introduced. This may be before the second card, after the second card, or at any stage during the game, but always before it is the player's turn to play/receive a card.

Version Two—Suited Pair

In this version, a player places a wager and both the player and a dealer receive two cards face down. A player can win if the two cards form a pair of the same suite. Depending on the math, this may pay 1-1 or 3-2. If the two cards form an unsuited pair, the player, depending on the math, may lose all or 50% of the wager.

With a suited pair, the dealer would beat all hands. If both dealer and player have been dealt a suited pair, the highest pair would win. A pair of sixes would be highest pair and a pair of Aces the lowest pair. The dealer, depending on the math, may also beat all hands with an unsuited pair, except when the player has been dealt a suited pair.

If no pairs have been dealt, the game continues with the same criteria as in the first version. The player however, must decide which of the two cards will “play” and draw the next card. For example, if the player is dealt a 6-3, the optimum strategy would to play the six, effectively requiring the next card to be lower. Therefore, five of the six possible cards would ensure the player remains in the game. If choosing the three, the player would only have three cards to draw to: a four, five, or six. Most decisions are therefore based on simple math. For other decisions, however, (for example, with 6-1 and 5-2) the math is the same and it will be down to the player as to which card should play. Depending on the math, a player may win 1-1 if a number of correct cards have been reached. For example, if a player has had five successful “plays”.

Optional Wagers

A variety of optional side-wagers may be offered prior to the deal.

1. A dealer pair (a form of insurance) may pay 4-1 or 9-2.

2. A dealer-suited pair may pay 10-1 or 11-1.

3. Both of the above, but based on the player's hand.

4. A-four-card poker pay table based on the players and dealer two cards.

An example pay table would be:

Suited four-of-kind—200-1

Four-of-a-kind—50-1

Royal flush (5, 6, 4, 3 of the same suite)—30-1

Straight Flush—20-1

Trips—5

Two Pair—3-1

A pair of sixes—1-1.

Cash Game and Tournaments—Head to Head or Multi-Player

A button is used to determine the order of play with left of the button first to act and in a clockwise direction. All players ante and receive one card face-up. Those wishing to play make a further wager before receiving a second card. To remain in the game and not bust, a player's second card must be higher or lower depending on the value of their first card. If a player's first card is a six, five, or four, the second card must be lower in order for the player to remain in the game. If it is higher or if it forms a pair, the player is eliminated. Rounds of betting may be introduced before a new round of cards are dealt.

A combination of all the above may be applied to any of the versions for both casino and player versus player versions. A progressive jackpot may be offered for a player and dealer being dealt the same suited pair.

Bacca-Jack

Bacca-Jack is comprised of a variety of versions combining Baccarat with blackjack and/or poker to form a variety of unique and simple gaming options. The game of Baccarat is most popular in Asia and is a very basic non-skill offering. The object, therefore, is to not alter the basics, but to enhance the game further.

Standard Baccarat charges a commission up to 5% on the player's winning hand. Bacca-Jack, however, eradicates commission on a player's hand, but introduces a commission on the dealer's hand. This is likely to prove immensely popular with players. The other enhancement will be featured as the game rules are explained further.

The points or value of each card is at face value with Ace counting as one through to six counting as six.

Version One

This is a simple game of chance with no strategy involved. After making a wager, all players and the dealer are dealt three cards and must use two of them to form the highest possible total not exceeding nine. If the three cards are 466, 555, 556, 566, or 666, then there is no way to make a two-card hand totaling nine or less. Those three-card hands are said to “bust.” Player busts always lose when the dealer doesn't bust. Dealer busts always push.

The house edge of this game comes entirely from the asymmetry in the treatment of busts. Player and dealer each bust on 49/1081=4.53% of the hands, and there is a double bust 0.14% of the time, which means that 4.39% of the hands where the player busts and loses correspond to 4.39% of hands where the dealer busts and pushes. This gives a house edge of 4.42%.

In a variation, players achieving a suited 6-3 in their first two cards can be paid 3:2 (assuming the dealer does not have a nine). This subtracts 365/35673=1.023% from the house edge, leaving a house edge of 3.37%. If the same thing is done for suited 5-4, the house edge drops to 2.35%.

This game can be played with a “bust insurance” side bet that pays 19:1 or 20:1, giving a house edge of 101/1081=9.34% or 52/1081=4.81%, respectively. Another option is to offer a three-card side bet, referred to herein as Flush Plus.

Pay Table 1: Suited 3 of a kind 10:1, 3 of a kind 5:1, Straight Flush 4:1, Straight 2:1, Flush (including Pair Flush) 1:1, Unsuited Pair or High Card Loses. House Edge: 5.18%

Pay Table 2: Suited 3 of a kind 10:1, 3 of a kind 10:1, Straight Flush 3:1, Straight 3:2, Flush (including Pair Flush) 1:1, Unsuited Pair or High Card Loses. House Edge: 4.26%

Progressive Jackpot

Tie on two occurs one time in 438,268.3 deals (requires six cards out of six to be Aces)

Player Score Distribution

0—4.53%

1—0.00%

2—0.32%

3—1.30%

4—2.91%

5—5.55%

6—9.76%

7—21.28%

8—25.49%

9—28.86%

0=bust

Version Two

This version has two enforced wagers in a showdown versus the dealer. One wager is for the Baccarat hand, wherein the best points score to nine wins, and the other wager is for the best poker hand. The rules are fluid and can offer various combinations as to how the hands are formed. One option is a non-skill version in which two of three cards are used to form the highest Baccarat score (to Nine) and all three cards are used to form a three-card poker hand.

Skill Version

A skill version involves the player using judgment in choosing two of the three cards to form both the best Baccarat score and a two-card poker hand. The ranking of hands will be determined by the final math.

The dealer will play to different rules and must prioritize the best Baccarat score before taking into consideration the best poker hand.

Player and dealer can bust if two of their three cards cannot create a Baccarat score of nine or lower. This will happen 6% of the time by being dealt a combination of 6, 6, 6 or 5, 5, 5 or 6, 6, 4 or 6. 6. 5 or 6, 5, 5.

If the player is first to act, as in blackjack for example, this will create a house edge of 6% as the player can bust before the dealer's hand comes into play.

In all versions, an optional tie wager would also be offered. This may pay according to a pay table or specific odds, such as 5 for 1. An example pay table for ties would pay these possible odds.

Tie on a score of nine—4-1.

Tie on a score of eight—4-1.

Ties on a score of seven—6-1.

Ties on a score of six—10-1.

Tie on a score of five—20-1.

Tie on a score of four or less—80-1.

A progressive jackpot may also be introduced and could be won when a player and dealer tie with a score of two. For this to occur, both the dealer and player must be dealt three Aces each. This could be expanded further to include a tie on a sore of two or three.

In order to reduce the number of ties, the highest card may come into play or a suited score would beat the same score if unsuited. For example, a score of nine from a 6-3 may beat a score on nine from a 5-4 or a suited 5-4 may beat an unsuited 6-3.

Bacca-Jack—Multi-Player Version

The object is to use two of the three cards to create the best baccarat score closest to nine. Players place an enforced wager and are dealt two cards with an option to be dealt a further card. If a third card is not taken and the player wins, it will pay either 3-2 or 2-1. If a third card is taken and the player wins, it will pay 1-1. Another option is for all three cards to be dealt, utilizing two of three to form the best baccarat score. Any combination of the above versions and rules may be combined.

Texas Five

This game has several variants. In all forms of the game, players make an ante bet and then players and dealer each receive two “hole cards.” Players may then choose to fold and lose their ante bet, or they may choose to make a “raise” bet which is a fixed multiple of their ante bet. In one variation, players may choose to “surrender” half their ante bet rather than folding and losing all of it; in another variation, there is no raise bet and no strategy.

Three “community cards” are dealt and the player and dealer five-card hands formed from their hole cards and the community cards are compared according to the following ranking from highest to lowest: 5 of a Kind, Straight Flush, 4 of a Kind, Full House, Straight, Flush, 3 of a Kind, 2 Pair, 1 Pair, High Card.

Note that 5 of a Kind, 4 of a Kind, and Full House can be suited or unsuited with no difference in ranking because they outrank a flush, but that suited 3 of a Kind, suited 2 Pair, and suited 1 Pair count as flushes and outrank flushes of unrelated cards.

If the dealer's hand “qualifies” with 1 Pair or better, then both the ante and raise bets are settled at even money. Depending on the version, ties may push or count as wins for the dealer. If the dealer does not qualify, then there are several ways the bets may be settled: ante bet pushes, player wins raise bet; raise bet pushes, player wins ante bet; ante bet pushes, raise bet settled at even money; raise bet pushes, ante bet settled at even money;

The following variations may exist:

Version A

The raise is two units. If the dealer does not qualify, the ante bet pushes and the raise bet is settled at even money. The optimal strategy involves folding 5.67% of the time, the house edge is 5.41% of a unit bet, and the average bet is 2.89 units.

Version B

The raise is two units. If the dealer does not qualify, the ante bet pushes and the player wins raise bet. The optimal strategy involves folding 5.67% of the time, the house edge is 3.84%, and the average bet is 2.89 units.

Version C

The raise is one unit. If the dealer does not qualify, the ante bet pushes and the player wins raise bet. The player may surrender and lose 0.5 units of ante wager. The optimal strategy involves surrendering 11.35% of the time, the house edge is 3.37%, and the average bet is 1.89 units.

Version D

In this version, no raising or folding is allowed, all hands qualify, and the dealer wins ties. The house edge is 3.88%, and bet always one unit.

Version E

The raise is one unit. If the dealer does not qualify, the ante bet pushes and the player wins raise bet. The optimal strategy involves never folding, the house edge is 5.43%, and the optimal bet is always two units.

All variations can be played with a side bet based on the player's 5-card hand rank, independent of the dealer's hand. Two pay tables are possible (“to 1” basis: 0=push, 1=even money), as shown in Table 2.

Texas Five Progressive: Tie on 5 of a kind occurs 1 in 1,533,539 deals (requires seven cards out of seven to be the same).

One-Card Poker—Custom Deck

The object is to offer a variety of wagering options based on the best five-card poker hand. Four of these cards will come by way of a community board. To complete the best five-card poker hand, one card from the six different value cards will be used to determine the best five-card hand. The six cards are Six, Five, Four, Three, Deuce and Ace. Each of these six cards (known as the wagering cards) will represent both suites.

Therefore, irrespective of what the community board may be, one of the above named wagering cards, along with four cards from the community flop, will be used to determine the best possible five-card poker hand.

For example, the board may be comprised of the following four cards: 2, 3, 4, and 5. In this case, the best card from the thirteen wagering cards would be a 6, making a six-high straight comprising 2, 3, 4, 5, and 6.

In any instance when the community flop contains four or more cards of the same suit (ensuring a flush is the highest hand) the winning wagering card will be always be the Six, irrespective if the Six forms part of the community board.

The odds and payout will vary on each card with Six offering the least odds and Ace offering the highest odds. The following outs are an example and may differ depending on the final math.

Ace—14:1

Two—11:1

Three—8:1

Four—5:1

Five—4:1

Six—3:1

Other Wagering Options

A pay table will be used to offer a variety of odds and wagers based on the best five-card poker hand based on order of rank. The following is an example ranking of the hands, but may differ depending on the final odds.

Five-of-a-kind suited, with 6-6-6-6-6 as high and A-A-A-A-A as low

Any five-of-a-kind with Sixes high and Aces low

Four-of-a-kind suited with Sixes high and Aces low

Four-of-a-kind

Royal Flush 6-5-4-3-2

Straight flush 5-4-3-2-A

Two pair

Group Wagers

The six wagering cards can be split into two or three groups. To create a house edge, this may require the groups to have uneven number of wagering cards representing the group. For example, 6-2 may form one group and 3-4-5 may form the other group. In effect, the Ace is excluded from groups in order to create a house edge. This can be expanded to three groups with the six forming one group, and a combination of two each from 2-3-4-5 to form two other groups.

Top Two Exacta

This would require the Six to win followed by Five being the second best hand. For example, the community board is 6-5-2-1 meaning the Six forms the best hand with a pair of Sixes followed by a Five.

Top Trio Trifecta

This wager will require the 6-5-4 and to create the best three hands—for example, the board is 6-5-4-1 or 6-6-5-4, etc. Again, the math may dedicate the need to mix the selection of wagering cards to create the three groups. Odds may also vary.

Jackpot Jokers—TV Game Show

In one embodiment, this game includes one host with two teams or two players. It could be expanded to three teams. This game also includes one poker table, one dealer, one electronic board containing 26 secret pairs of Deuces through to Aces—13 black pairs and 13 red pairs.

In one embodiment, teams answer a question. A buzzer is used and a correct answer gives the team control of the board and game. An incorrect answer results in the opposing team having control. The team in control would play first and chose one of the 26 secret pairs. The other team would also choose one of the pairs. These will be revealed to the viewers and to the respective teams, but not to both teams.

The team in control would now have the option to stick or switch, meaning that they could swap pairs with the opposition team. Once stick or switch has been chosen, the dealer and poker table come into play. Holding the higher pair ensures an advantage to a team, because the next stage is the prize deal round.

Prize Deal Round

The dealer will shuffle and deal four prize cards. These will either contain money or prizes. Prize cards can be comprised of two colors. Usually these colors will be on the face of the cards and not the back, although the alternative is possible. These two colors can be, for example, red and blue, can be predetermined prior to the game, and they will represent the colors of the two teams. The Prize Deck may contain an equal number of red and blue prize cards.

The dealer can deal out four prize cards. In one embodiment, the team whose color appears more on the prize cards will win the prizes. Therefore, when it is a tie with two colors each, the team with the highest pair going into the prize deal wins the prizes. A bonus may exist for when all four prize cards are of one color.

In instances when both teams' secret pair is the same and, irrespective if the switch or stick option has been taken, the team in control of the board will win all the prize of that particular prize deal.

The same format and process may continue with however many rounds are required to cater to the game length. The value of the prize cards could increase with each round to ensure both teams will have a chance to progress to the final, irrespective if one team is leading by some distance. The winning team (most money won) could advance to the final and Jackpot Jokers round.

The Jackpot Jokers round will again feature a prize deal of five or six cards depending on what number may create more excitement. The number of prize cards contained in this deck may be dependent on the number of correct answers against a time clock. Added to this deck will be three more cards—two Jackpot Jokers and one Bad Beat Card. When the Bad Beat Card is dealt, contestants lose all prizes unless at least one of the Jackpot Jokers is also dealt.

To win the jackpot, the two Jackpot Jokers must form part of the cards dealt. Therefore, the fewer prize cards used in the deal, the higher the odds of winning the jackpot. For example, 20 prize cards will be used. This number would decrease to 19, 18, 17, 16 or 15, depending the number of correct questions. More correct answers=less prize cards=higher probability of both Jokers being dealt and the jackpot won. Reaching a set number of correct answers during the time clock round would eliminate the Bad Beat card from the jackpot round.

Optional Bounties in Poker

Optional bounties allow a player to choose the amount of the bounty that the player is placing on his or her elimination. For example, $50. The amount is important because whatever amount the players chooses, that is the maximum amount the player can win by eliminating another players.

For example, player (a) has chosen a $50 bounty and eliminates player (b) with a bounty $100. Player (a) would therefore win $50 and $50 would be returned to player (b). If player (b) eliminates player (a), player (b) would only win $50.

There are basically two forms of poker tournaments involving the distribution of monies. Tournaments with bounties and tournaments without bounties. Bounty tournaments are growing in popularity. It is a structure that players have embraced. It allows the winning of monies simply by eliminating a player and, as such, there is less variance in a player's bankroll.

By introducing optional bounties, poker is taken to another level not only in enhancing player experience, but from the perspective of the operator as well.

For example, Pokerstars.com is by far the busiest of the online operators and would no doubt maximize the potential of optional bounties through their many thousands of tournaments run each day. By implementing this feature, not only would players appreciate the option, it is an opportunity to increase revenue by charging a small fee to each bounty. Just as importantly and for the first time, optional bounties can be offered across the board to include sit and goes, a the term used for tournaments limited to a number of players. Although the number of players can vary, these normally range from two to ten players.

The impact optional bounties could have cannot be stressed enough. For example, in small buy-in events and large fields, especially in the case of Pokerstars, which runs many such events, a player may beat several thousands of players and yet, not show a return. With optional bounties, there is an opportunity to make a profit from such events simply by eliminating one player.

For example, one particular tournament, The Sunday Storm (a $10 buy-in, in which the first prize is over $30,000), attracts between 30,000 and 50,000 players. In effect, a player may beat 35,000 players and lose $10. Optional bounties will therefore dramatically impact tournament poker.

Another example is the Spin and Go feature implemented by Pokerstars. This sees just three players playing in a fast-paced sit and go in which the prize money is based on a random number generator (RNG) and can vary dramatically. For example, a $5 Spin and Go can generate anywhere between $10 and $1,000,000 to the winner. In order for this to be possible, it requires that the $10 prize be generated most frequently and by a huge percentage. This tends to impact the game in a negative manner, as players tend to get bored of the format and playing for such a small return.

By allowing optional bounties, the Spin and Go is format is transformed. It may still be dependent on the RNG for winning a major prize but it would offer players more options and control. For the operator, it would enhance their product offering and make Spin and Go even more popular.

Much importantly however, is the overall impact optional bounties could have on the less busy sites in which the majority of players tend to be small-stake players. Therefore, it is a never-ending battle to cater to mid-stake or high-stakes players. Optional bounties could bring players of all groups close together.

For example, a $10 buy-in would only be attractive to small-stakes players. With optional bounties, however, it would attract mid-stakes players. A $30 buy-in tournament is ideal for mid-stakes players but with optional bounties, it would attract the higher stakes players.

This is especially true in sit and goes. Whereas the $10, $20, or $30 buy-ins may prove popular, it is far more difficult to find games more suitable for higher stakes players. Option bounties can bridge that gap.

Optional Bounties can also impact live tournaments for the above reasons and will be explored for implementation through mobile and online. A bounty bonus could also be introduced to encourage players to utilize the feature.

Fantasy Poker Tournament (FPT)

FPT is method of presenting a fantasy tournament in which the generated prize pool or prize pool will be distributed to winning entrants based on the results of an actual online tournament. FPT will, in effect, allow an online gaming operation to offer a form of staking or backing of players playing in a poker tournament. The staking or backing of players in not only a part of poker, it has grown in recent years with a number of operations now offering a staking service.

The staking of a player would normally see a variety of returns to a backer. For example, a backer may pay 100% of player's entry fee into a tournament. In return, the backer will seek a percentage of any winning returns. In some cases, this percentage can be as little as 40%, rising to 70% or even 80%. FPT will allow a backer to stake players for a 100% of returns.

It's important to note that FTP will not require interaction or any agreement for one player to stake another. Also, the operator would distribute winnings to all players as is standard with any online tournaments.

By offering FPT, not only would an operator dramatically increase revenue, it would attract those simply looking to invest in the performance of another player. It is therefore important that a player's current form be made available, for example, a player's last twenty tournament results. This would allow FPT players to use their skill and judgment in choosing a player to ‘stake.”

The following examples show how an operation may implement FPT:

An online tournament has an entry stake of $100. Players registering in this event will be offered in a variety of fantasy events. In this example, there would be four fantasy tournaments (this number be lower or higher) with different entry stakes: $100, $50, $25 and $10 or any amount of entry. Players therefore, looking to enter a fantasy event, may wish to enter any, or all four, fantasy events. This will be offered on a first come, first served basis.

This would, therefore, create five different tournaments and five different prize pools, as the number of entries for each tournament may vary. For example, the real live online tournament may have 1,000 players. The $100 fantasy may have 200 players and the $50 may have 250 players. Irrespective, a “staked” player would only need to beat the other players within the selected fantasy tournament.

For example, a player has staked player (a) in the $100 fantasy tournament. That player may in effect, win the fantasy tournament for the backer and still only place 251^{st} in the online tournament if, of course, none of the 250 players placed above have been staked in the $100 fantasy tournament.

Another option is to first offer the fantasy tournaments to the player playing in the online event. If that player declines any of the four fantasy tournaments, that player would be made available for others to stake. In effect, one online tournament could generate multiple entry fees for the operator, and, as such, increase revenue.

Another option is to allow players to form their own fantasy prize tournament and prize pool. This could be limited to friends or to a certain number of fantasy players. In fact, as long as two players take part in a fantasy tournament, then it would still create extra revenue.

Apart from attracting “investors” or “backers,” an operator can offer the less-skilled players an opportunity to invest in proven players. Just as importantly, time constraints are not a factor. As such, players may make their investments and not be actively engaged in the game. Either way, FPT offers such a unique and marketable feature that can be very much appreciated and enjoyed by the vast majority of players.

One-card Poker for Player Versus Player for Both Cash Games and Tournaments

There are many possible versions available to this concept. In one version, players are dealt two of the ‘wagering’ cards, in which either of the two will be used to create the best five-card poker hand in connection with four of six community cards.

It is also possible to deal players more than two ‘wagering’ cards to create the same game. With thirteen wagering cards however, it limits the number of players on each table. For example, if players are dealt two wagering cards, the most the game could accommodate is six players to a table. If players are dealt three wagering cards, this can accommodate four players. If players are dealt four wagering cards, the game can accommodate three players.

As it is best to include the possibility for players to bluff, the best format may limit the number of players to four and see players being dealt two wagering cards. In effect, eight wagering cards from thirteen would be in play, leaving five wagering hands not in play. This would mean that a player could succeed with a bluff five times from thirteen attempts. However, bluffing is very much dependent on the action of players in the hand.

With players being dealt three wagering cards, it would be almost impossible to bluff if four players are seated at the table and all four are involved in the hand. It would therefore seem that three wagering cards would be better suited to restricting each table to three players.

Standard Deck of Cards

By removing wagering cards and using a standard deck of cards, the game could accommodate nine or even ten players per table. There is also immense flexibility in how many cards each player is dealt before the community board of six cards is dealt.

In effect, as long as players only use one card from their hand and four from the community board, the game format remains the same. The number of cards dealt to each player therefore can range from 2, 3, 4, 5 or 6 more cards. Irrespective, a round of wagering may take place before any community cards are dealt.

To begin with, four community cards are dealt face up, known as the “flop.” Then follows another round of betting before a fifth community card is dealt face up. A further round of betting takes place before the sixth and final community card is dealt face up. Then follows a last round of betting.

In this format, the number of cards dealt to each player determines the action generated. The more starting cards dealt to each player, the more likely that each hand will have multi-way action pre flop. That may decrease after the flop, as in normal poker, but strategy is extremely simple to apply.

In order create even further action pre flop and post flop, the number of community cards can be increased. For example, seven community cards can dealt with perhaps five on the flop, one on the turn, and a final card on the river. If the number of community cards are increased, so is the number of community cards on the flop. For example, if eight cards are dealt, then six cards will be dealt on the community board.

One-Card Poker may differ dramatically from standard forms of poker. Its simple strategy would appeal to those of limited skill or those wishing to see more fun and enjoyment at the poker table. What is important to note is that players dealt pairs in their starting hands would be advised not to play the hand as pairs restrict option dramatically. Players will therefore tend to see fewer flops. In order to eradicate this, the RNG (Random Number Generator), can be programmed to avoid dealing pairs to players. It would still be random dealing but will ensure more players entering a pot. This may be important, because action after the flop will tend to be limited to two or perhaps three players at most. By eradicating the possibility of players being dealt pairs in their starting hands, more action is created.

One-Card Poker is seen as a format that will appeal to the masses. Very importantly, it will dramatically reduce the possibility of the best hand losing too often. Overall, it is a fun variation for poker players of all skills.

Possible Additions

The aim behind One-Card-Poker is to address the need from online poker operations to offer a poker variation that appeals to the recreational player as opposed to the professional player. Just as importantly, there is a need for a variation that can somehow level the playing field and reduce bankroll variance. The above-mentioned formats do this by limiting the action and skill requirements. Furthermore, there is the flexibility to also add further versions.

One such version does not generally allow for extra skill and strategy, but can do so by restricting action.

One-Card Poker+Pairs.

Irrespective of how many cards are dealt to each player, any pairs within the hand will be very much disadvantages. One possible is for the Random Number Generator to exclude pairs being dealt to a player.

In One-Card Poker, one benefit is how the format dramatically reduces the possibility of the best losing. This is paramount to creating a structure where strategy and mathematical probabilities rule, not luck. For example, many hands of poker are based on 50-50 chances, 60-40 and 70-30. This format will reduce those odds to 80-20 and 90-10. In effect, the best hand will win more often.

The format also creates many situations in which two or more players share the same winning hand. In some cases, if there are more community cards to be dealt, each player may have between 0% and 20% of improving to a better. Irrespective, the format creates a much friendlier format of poker and also reduces the skill requirements.

One-Card Poker-Custom Deck of Playing Cards

This custom deck may consist of two suits, circles and squares, two colors, and eights sets of cards from One or Ace through to Six (one set of four for each suite and each color). In effect, the cards represent dice. In this deck, six is high and Ace is low.

Players have the option to wager on any of the six possible wagering cards prior to a dealer dealing four cards face up—known as the community board. The community board is added to by one of the six wagering cards that would combine with the community to create the best possible five-card poker hand.

It is important to note that each wagering card represents both suits and colors. For example, when the board has four cards to a possible straight or four cards to a possible flush, using the missing card from one of the six wagering cards would complete the flush or straight. For example, if the community board were comprised of 2, 3, 4, and 5, the 6, from the wagering cards, would be added to complete the best possible five-card hand.

The same applies for a board of four cards to a flush. Therefore, for any community board with four cards of the same suit, the Six of that suite would be added to form the flush. This is irrespective if a Six of the same suit forms part of the community board. This will be a fairly regular occurrence due to each card represented four times in each deck.

Wagering cards will offer different payouts with an Ace or One offering the highest odds to a Six offering the lowest odd. The pay table will be dependent on the final. The following is an example pay table.

An Ace pays 12 for 1; a Deuce pays 10 for 1; a Three pays 8 for 1; a Four pays 7 for 1; a Five pays 5 for 1; and a Six pays 4 for 1. All odds may pay higher or lower based on the final math.

Oops Poker

Oops Poker is a format that allows poker players an opportunity to forfeit a percentage of chips when all-in in any specific hand during either a tournament or cash game. The object of Oops Poker, therefore, is to offer another option in how poker is played.

All current poker formats ensure that luck plays a major role in certain hands, and at crucial times. For example, in Texas Hold'em, the two biggest hands are two Aces versus two Kings. In this scenario, one of the two players will be extremely unlucky and the other extremely lucky. In this scenario if the two players are all in before other cards are dealt to complete the hands, the two Aces are very strong favored with approximately 83% probability of winning. In effect, it would be down to luck and the percentages. Irrespective, luck has played its part by two players having the best two possible hands in a showdown.

The Oops option would therefore come into play by offering the player with the worst odds of winning an opportunity to forfeit a percentage of his or her stack.

The forfeit percentage could be flexible and work on a sliding scale, whereas the percentages of winning can be used as a guideline. In the above scenario, if the player holding a pair of Kings takes the Oops option, he would forfeit 83% of the chips committed into the hand.

However, that may be deemed too high a percentage and would defeat the object of reducing the luck factor in poker. The other option, therefore, is to offer a set percentage of perhaps 50% to be forfeited when a player chooses the Oops option.

Although Oops is seen as primarily an option for when two players are all in with more cards to be dealt to complete the hand, it is possible to offer the option with multi-way all-ins.

Bounty Frenzy

Bounty Frenzies are poker tournaments in which the entire entry fee (or a large percentage) goes towards a bounty on each player. There are a variety of options for Bounty Frenzy. One option is to allow players to leave a tournament after gaining a minimum number of bounties, for example, five, before they are allowed to leave the event. This number could be adjusted in accordance to number of entries. For example, 5 for up to 100 entries, 6 between 101 and 150, and 7 over 150.

As the tournament progresses, many interesting scenarios will be presented. When a player wins a bounty by busting another player, the bounty value of the winner increases. This format continues all the way to the completion of the tournament.

In one embodiment, a tournament will conclude when the expiration of a time limit is reached. This embodiment may have a fats structure.

Poker Side-Bet (PSB)

PSB uses the points value of a standard deck of playing cards to create a variety of wagers. For example, cards ranging from Deuce to a Ten will be worth their face value of two points through to ten points. All pictures of face cards will also count ten. However, depending on rules, face cards may be allocated a higher scoring value. For example, Jacks=eleven points, Queens=twelve points, and Kings=thirteen points. By using this points scoring system and a community flop containing three cards, the points total is used to create optional side bets. Players may be offered the option to wager on three separate points.

Group One—low points score: The minimum points score possible in this group is three (three Aces). The range of points in this group is dependent on the math and may range between three and nine points. This point's number may be increased or reduced.

Group Two—high points score: The highest score in this group is 33 (three Aces).

Group Three—middle points group or “field bet”: This group will feature a section of points that are not included in either the low or high groups. This number is also dependent on math but there will a selection of points that will not be available in any of three groups. This is seen as the ‘house” points score and the range will depend on the required house edge.

Pay Tables

The object is to create wagering options that offer both short and long odds—it is a simple matter of reducing or increasing the points requirement for each group.

An example pay table for the low group is:

3, will pay 80-1

4, will pay 66-1

5 will pay 30-1

5 will pay 10

7 will pay 2-1

8 and 9 will pay 1-1.

The high group will have similar payouts. Three Aces on the flop will mean that both the high and low group will pay out. The middle group of point scores will obviously be more common and, as such, will pay shorts odds. This, again, is dependent on the math. Optional winning may be included in one or more of three groups. For example, a flop containing three cards of the same suit or of the same value.

Hi Lo Points Poker

Version One

By using the same point's value, a flop of three cards is used to create a fast-paced and exciting slot game that can also utilize the multi-play slot market. Players will have the option to hold one, two, or all three cards. In very rare circumstances, players may decline to keep any of the three cards. The object is to accumulate a points score by using all three cards. In order to win, the points score must fall within two groups, one with a low points score and the other with a high points score.

The pay table and the number of points required will be dependent on the math. The odds will vary dramatically with the longer odds being on the lowest or highest score. In this case, three Aces will count as lowest (3 points) or highest 33 points. In effect, the jackpot hand would be three Aces.

Based on the math, it is expected that each group may have between five and seven winning points score. These will pay from a minimum one credit. The max pay out will vary.

Version Two

In another version, the dealer will deal four cards instead of three, and players must hold at least two of the four cards to create a points score. The pay table may vary from version.

Version Three

In another version, the dealer will deal five cards, and players must hold at least two of the four cards to create a points score. Again, the pay table may vary from the first two versions.

Points Poker

Points Poker is simply replacing poker hands with points by using the face value of standard playing cards. The object is to create a fun and simple game that brings down the barriers in terms of the skill required.

Winning Hands

Points Poker is a split game in which 50% is paid to the hand closest to a point's total of forty-one and the other 50% paid to the hand closest to a points score of fifty-one. The points total used to determine the winning hands may be or lower or higher than those stated.

Rules

Each card is counted as face value with Aces counting as either one or eleven and all face cards counting as ten. The game is played in the exact same format as a standard game of Texas Hold'em poker. Players are each dealt two cards face down and a round of betting takes place. A flop of three community cards is the dealt and another round of betting takes place. A fourth card (the turn) is then dealt and another round of betting takes place. A fifth card (the river) is dealt and another round of betting takes place.

Players must use the point's value of both their two down cards and add that score to the point's value on the cards dealt on the community board of five cards. It is important to note that the points added from the community board must be in sequence until the player has exceeded the point's requirement. For example

A player has been dealt a point's score of 20 and the community flop of three cards show the value of nine, nine, four. The player's total score will therefore be 38 (using his twenty and the first two nines on the flop). The four does not come into play at this stage because the target of forty-one points has been exceeded.

However, the next target is fifty-one points and therefore the third card on the flop (four) comes into play. In effect giving the player a total point's score of forty-two.

If the turn card value is nine or under, that value will be added the score of forty-two. If the value of the card is over nine, the closest points score to fifty-two will in this case be forty-two.

Using the same points value of cards and a community flop containing three cards, the points total is used to create optional side bets. Players may be offered the option to wager on three separate points.

Group One—low points score: The minimum points score possible in this group is three (three Aces). The range of points in this group is dependent of the math and may range between three and nine points. This point's number may be increased or reduced.

Group Two—high points score: The highest score in this group is 33 (three Aces).

Group Three—middle points group or “field bet”: This group will feature a section of points that are not included in either the low or high groups. This number is also dependent on math but there will a selection of points that will not be available in any of three groups. This is seen as the “house” points score and the range will depend on the required house edge.

Pay Tables

The object is to create wagering options that offer both short and long odds—it's a simple matter of reducing or increasing the points requirement for each group.

Example for low group

3, will pay 80-1

4, will pay 66-1

5 will pay 30-1

5 will pay 10

7 will pay 2-1

8 and 9 will pay 1-1.

The high group will have similar payouts. Three Aces on the flop will mean that both the high and low group will pay out. The middle group of point scores will obviously be more common and as such, will pay shorts odds. This is again dependent on the math.

Hi Lo Points Poker—Version One

By using the same point's value, a flop of three cards is used to create a fast-paced and exciting slot game that will utilize the multi-play slot market. Players will have the option to hold one, two or all three cards. In very rare circumstances, players may need decline to keep any of the three cards. The object is to accumulate a point's score by using all three cards. In order to win, the points score must fall within two groups, one with a low point's score and the other with a high points score.

The pay table and the number of points required will be dependent on the math. The odds will vary dramatically with the longer odds being on the lowest or highest score. In this case, three aces will count as lowest (3 points) or highest 33 points.). In effect, the jackpot hand would be three aces. Based on math, it is expected that each group may have between five and seven winning points score. These will pay from a minimum one credit. The max payout will vary.

Shootout—50-50

Shootout—50-50 is a tournament format in which 50% of the players on one table advance to the next round. This is applies to tables of 4, 6, 8 or 10 players.

Some of the benefits include, but are not limited to, (1) no breaking of tables; (2) no moving players; (3) no hand-for-hand; (4) reduces slow play; (5) by seeding players after the first round (based on chip stacks) it ensures that chip stacks will be more evenly spread throughout an event, which will prove paramount in eradicating the luck factor of the draw and ensuring a level playing field during the late stages of an event (for example, with the current format and with three tables remaining, it is possible that one table may contain all the top nine stacks); (6) dramatically reducing the luck factor associated with all the above; (7) option of playing to a conclusion (when 50% of players remain) or when a pre-determined number of levels is reached (wherein it is essential that slow play is eradicated by introducing a minimum number of hands to be played during the final level—if more than 50% remain after the final level, the required number of players to advance will be determined by chip stack); (8) dramatically increasing interest in televised events as each table is played to a conclusion; (9) providing an enhanced shootout format, wherein players are offered an even chance of advancing rather than the standard 10-1 chance; (10) eradicating the unnecessary luck associated with many aspects of a standard tournament, which means the skill factor can be taken to a final table allowing players to apply the different strategy that is required for full table and for short-handed play; (11) dramatically reducing the workload of tournament staff; and (12) providing a flexible format that can be introduced for 10-handed events, 8-handed events and 6-handed events.

Fantasy Racing Odds

Points are awarded for predicting the winning odds of selected races.

Possible returns in dollars and cents

(a) 2.00-3.99

(b) 4.00-5.99

(c) 6.00-7.50

(d) 7.51-9.99

(e) 10.00-12.49

(f) 12.50-14.99

(g) 15.00-17.49

(h) 18.50-20.99

(I) 21.00-23.49

(j) 23.50-25.99

(k) 26.00-28.49

(L) 28.50-31.99

(m) 32.00-35.99

(n) 36.00. 42.99

(o) 43.00+

The above list of fifteen groups could be increased or decreased depending on requirements. Irrespective, the object would be for players to select a set of eight groups from (a) through (o). This set of groups must be placed in preferred order based on the following rules.

A player will be given a set number of horse races (for example, 10) from a number of racing tracks. The object would be for players to study these races and determine the winning returns from each race. They must then use their skill and judgment to try and calculate the most frequent odds returns. For example, if many of the races have very short odds, then (a) is likely to be a common return. If on the other hand, the races are very open with large fields, the middle groups of (d), (e), and (f) may fair better.

Each horse race will in effect ensure that the returning odds will fall within one of the groups. Points are gained for the group when it the returns match one of the odds options. However, the number of points gained will be determined by the order in which the set of eights groups are chosen. For example, a player can choose these eights groups and place them in the following order: (b), (d), (a), (f), (g), (h), (o), (f). The scoring for this player will be as follows. Each time a return is matched to (b), that player scores 20 points. When it is matched to (d), the points score is 18. (a) scores 16 points and so forth down to 6 points for (f). Therefore the order of preference is paramount to the points score.

Various bonus points could be awarded. For example—100 extra points if all 8 selections score points. Double points for the last race, etc. All points will count double for the first group chosen by the player. In the above example, all points gained by group (b) would count double.

Fantasy Single

This is based on the outcome of a one specific race. Players are required to select a group of numbers and place them in order of preference. These will correspond to actual horses in the selected race. In this example, the selected race consists of 12 horses, numbered 1 through 12. Players will therefore need to select 12 numbers and place them in an order that they believe all 12 horses will finish the race. In this case, there will be 12 scoring factors—A through K.

In this example, a player has selected all 12 in order—with number 1 being first choice and 12 being 12^{th} choice. Therefore, number 1 would be placed in A, 2 in B, 3 in C, etc.

In effect, players will score points with each horse, irrespective of final placing. What will determine the winners, is the order of the their selections. Scoring is as follows for 1^{st} through 12^{th} in the selected race: 15, 13, 11, 10, 9, 8, 7, 6, 5, 4, 3, 2. These points are multiplied by the following scoring system: A×12, B×11, C×10, D×9, E×8, F×7, G×6, H×, 5, I×4, J×3,K×2.

In this example, “A” represents horse number 1, B, represents horse number 2, C represents horse number 3, etc., down to K representing horse number 12. As an example, the race results were as follows: 12, 3, 1, 5, 6, 7, 4, 9, 10, 8, 11, 2.

Our player therefore scores as follows:

(A), (horse number 1) finished in 3^{rd} place. Third place scores 11 points. This is multiplied by the X factor of A (12). Therefore, 11×12=132

(B) (Horse number 2), finished in 10th place. Tenth place scores 4 points. B has an X factor 11. The final score therefore is 4×11=44 points.

Fantasy Races

There are a few options in how multiple races can be incorporated into the fantasy format. And although this may not offer instant payouts, it may take as little as thirty minutes to conclude a game. Perhaps more importantly, it will give players immense fun and excitement. Points scoring will again determine winners.

The format is very simple. It simply requires entrants to select six numbers (this number is flexible and more or less numbers can apply) from a list of numbers corresponding with the numbers of horses from selected races. For example, if five horse races are selected to feature in this mini tournament (MT), then the list should include the highest number that applies to an actual horse. In effect, four races may have a max of ten runners (giving us a list of 1 through 10). If the fifth race has fifteen runners, then the list will contain numbers 1 through 15.

Therefore, every horse running within the selected races will have a number that corresponds to that horse. This rule applies to ALL the selected races in the MT. If a player therefore chooses number 2, the two horses in each of the five races may score points for that player.

As with the first format, selected numbers are required to be placed in order of preference as this order determines the number of points awarded. In effect, a scoring format similar to the single game.

In order to try and present this as a skill game, certain information on the races must be offered. In this case, it may be as simple as having the list of numbers (15), highlight the total number that each list number corresponds to a horse. In other words, we have five races with each race having the following number of runners.

Race 1-7 runners

Race 2-8 runners

Race 3-9 runners

Race 4-10 runners

Race 5-15 runners

If a player selects 6 numbers from 1 through 7, that player will have 6 horses that can score points in ALL races.

If a player's selection includes a number higher than 7 (for example, 9), then that player will have horses representing him in races of less than nine. Player's will therefore need to apply skill in every aspect of this game. It does not however, prohibit them from using the quick pick option.

The aim here is to present a game that will generate fun and excitement, while at the same time, trying to adhere to the USA legal requirements.

Cash Poker Tournaments

By setting a time limit, cash tournaments are seen as speed tournaments without reducing the skill factor. They also offer flexibility in terms of how they are presented to players.

One option is to have four thirty-minute levels.

A percentage of the original buy-in can be set aside to form four prize pools of equal value. Each of these prize pools will be used to create 4× Stack Races. These could be awarded to the chip-leader at the end of each level. The prize would be paid directly into the player's balance and not added to his chip stack.

Tournament starting chips will be $ for $. For example, if the buy-in is $150, $40 from the $150 buy-in will be the amount set aside for the four prize pools. If 100 players enter the event, there will be 4×$1000 prizes. Using the same example, players would therefore begin with a starting stack of $110.

Starting blinds will be around 400 to 5000 big blinds. Subsequent blind increases (if any) could be kept small as the object is to give player ample play.

In the above example, players would begin with $110 in chips. Therefore, the blinds could begin at 10-20 cents. These could rise after each level. For example, 20-40 cents, 30-60 cents and 40-80 cents.

A progressive jackpot could be offered for any player collecting all four $1000 prizes in a single event. Therefore, a $150 buy-in would be broken down into the following sections. $100 would be the starting stack. $40 would be set aside for the 4×$1000 chip-leader prizes. $10 would be added to the running jackpot prize pool, with perhaps 80% of this paid to any player winning all 4×$1000 prizes and 20% paid to any player winning three of the 4×$1000 chip-leader races.

The format is flexible and can be amended in a variety of ways. The most obvious of these is how much is taken from the original buy-in for the four chip-races and for the jackpot. Also, rather than have just a single prize for the four chip races as in the example used, three prizes could be offered. Example: $600, $250 and $150.

At the end of the four levels, players will leave the game with whatever chips they have remaining.

Another option is to simply create a Cash Tournament by which 50% of the buy-in is used to create a standard tournament with a standard prize pool payout. Using the same example of a $150-buy-in and 100 players, $75 will go towards the prize pool. This will mean that players will start with $75 in chips for the Cash Tournament. Blinds could begin at 10 cents 20 cents. Play will continue for the four levels. If ten prizes are awarded for the Cash Tournament, the top ten stacks will be paid according to position. For example, 1st place will be awarded to the chip leader and so forth down to tenth place going to player tenth in chips at the end of the four levels.

Another option is to create a Cash Tournament with a combination of the above two options. For example, $75 from the $150 will be used to not only create a Cash Tournament as above, but also create 4× Chip Races. Example, $20 of the $75 will be used for the 4× Chip Races while $55 will be used for the actual Cash Tournament.

Another option is base the four payouts based on the number of hands won and not the size of the players stacks.

Five Card Texas Player Versus Computer (Dealer) with Custom Deck

The custom deck comprises of two colors, red and black, and two suits, circles and squares, and eight sets of six cards from Ace through to Six, with four sets of each suit and color.

Two cards each are dealt to player and dealer. These are then used in connection with a flop or board of three cards to form a five-card poker hand. The player and dealer post and ante and the player or dealer has the option to call a predetermined wager or raise to a predetermined wager. If the player chooses to play, then the player must then decide if the bonus payout will apply to the hand and the amount of the bonus. This bonus is determined by the ranking of the five-card poker hand and is liable by the player and by dealer. The card ranking are based on face value. Therefore, Six is high and Ace is low.

The dealer will call, raise, or fold under a set criteria based on the dealers two cards. This will be determined by the final math. For example, the dealer will fold certain hands such as any Ace not suited or connected and will raise with high ranking hands such as 6-5 suited, pairs, and suited connected cards. The player will be advised to follow the same strategy.

The following bonus payout table is an example and will be determined by the final math. Five-of-a-kind suited, five-of-a-kind, straight flush, four-of-a-kind suited, four-of-a-kind, full house, straight, flush, three-of-a-kind suited, three-of-a-kind. The amount payable or paid out would be determined on the final math. The bonus is an optional wager. The original ante and wager is a shootout between player and dealer with best hand winning.

Fantasy Roulette and Bingo

The object is to create a fantasy format based on two of the most popular games of roulette and bingo and as such, offer a casino to generate a form of rake. Players will pay an entry fee and select a group of numbers that correspond with the numbers on a roulette wheel. This will range from either a single or double zero up to or including number thirty-six. This group may consist of one or more numbers dependent on the final rules. In this example, the group will consist of ten numbers. This group on numbers will then gain points each time one of these numbers has been called on either a live roulette or through an random number generator (RNG).

All entry fees minus any commission for the house would be used to form a prize pool in a tournament. A game will consist of a predetermined number is spins (for example, 20 spins). All points are then calculated to form a league in which prizes are distributed according to league position.

Tournaments sizes may vary and offer different entry fees similar to poker tournaments. The same format can be applied to bingo. In this, players would choose a group of numbers ranging from one to ninety.

Game One—Five Dice Poker

Five Dice Poker can be played by using a standard six-sided dice or symbols to create a five-dice poker hand. This can be expanded to using playing cards numbered Ace through to Six of through a custom deck of cards consisting of multiple sets of cards of ace through to six. Also, through by means of a dice shaker, electronic, digital or a mechanical device.

This version combines five dice to create a five-dice poker hand. In this version, two dice will be randomly allotted to players and to the house. A further three dice will be required to create the five-dice poker. These three dice will be rolled by a mechanical devise and would be added to the player's hand and to the house hand.

There are a possible twenty-one two-dice combinations and will form 40% of the five-dice poker hand. The combinations are as follows: 1-1 1-2 1-3 1-4 1-5 1-6 2-2 2-3 2-4 2-5 2-6 3-3 3-4 3-5 3-6 4-4 4-5 4-6 5-5 5-6 6-6.

Rules

Players place an ante and are allotted on the twenty-one combinations. The house is also allotted one the twenty-one combinations. Players must then, based on the strength of the two dice, either place a further wager to continue in the game or forfeit and the ante. The five-dice poker hands are then completed by the roll of three community dice through the mechanic dice.

There are two options in how the winning hand is determined as well as how wagers are paid. One option is to have a showdown with best hand winning. Option will allow for a minimum qualifying hand to apply to the house hand. These will be determined by the math and house edge requirements.

With option one, players may also place a single wager before the two-dice hand is randomly allotted in a straight showdown against the house. In order to introduce a house edge, the house would win all ties or players would have a percentage of the wager returned. For example, all ties and the players lose 50% of any wager.

Optional Side Wagers.

A bonus pay table would pay a variety of odds based on the ranking of the players' five-dice poker hand. The following is an example pay table. The final winning combinations and payouts would be dependent on the final math and required house edge.

6-6-6-6-6 100/1

Five of a kind 40/1

Straight 35/1

Full house 25/1

5 even numbered dice 10/1

5 odd numbered dice 10/1

3 of a kind—4/1

Two pair—3/1

All others lose

Tie the house optional wager—18/1

Progressive jackpot—tie the dealer with any five of a kind.

By color-coding two of three dice on the mechanical device, player and house maybe allotted three dice via the RNG and two dice from the mechanical device to form a five-dice poker hand.

Three-Dice Poker

Version One

Rules

Standard six sided dice or symbols are used to create a three-dice poker hand. Players must place an ante. Once a player has made the wager, the next a roll of three dice via the mechanical devise will determine the player's three-dice poker hand. Based on those three dice, players must then determine if they wish to raise or play by making a further wager, or forfeit the ante. If a player chooses to make that second wager and play/raise, the next roll of the three dice via the mechanical devise will determine the house hand. It is then a showdown with the best three-dice poker winning.

Qualifying hand for the house. Depending on the math, a qualifying hand may apply to house hand. For example, 6-4-1. If the dealer does not qualify, the player wins one for one on the ante and the second wager is returned.

A bonus payout may also apply to the player's hand. For example, 6-6-6. This will be determined by the final math.

Optional Bonus Wager.

An optional bonus wager may be offered and will be pay odds based the player's three-dice poker hand. This will be determined by the final math. An example pay table is as follows.

6-6-6 pays 20/1

5-5-5 pays 16/1

4-4-4 pays 12/1

Three-Dice Poker Using an RNG to Form Part of a Hand or an Entire Hand.

In this version, color-coding the three dice on the mechanical devise will allow players to be allotted one dice through and RNG and to complete the three-dice poker hand, two dice will be added from the mechanical roll of the dice.

Another option is a player to be allotted all the dice via the RNG to form a three-dice poker hand and the house would use all three dice rolled on the mechanical device. The above rules would also apply to this version.

Six and Five-Dice Poker

This version would again use the RNG to form part of the player's and house hands. One option is to have three dice allotted to both player and house via the RNG and for the mechanical roll to determine both hands.

The above could also apply to creating the best five-dice poker hand from the total of six dice. For example, if a player is allotted 6-6-6 through the RNG, then a further 6-6 on any two of the three dice rolled on the mechanical devise will form a ranking of 6-6-6-6-6.

Three Dice Baccarat

Rules

All dice count at face value.

As with standard Baccarat, the object if to score closest to nine in showdown between the player and the house. This points score must be obtained from a roll of three dice, but with both player and house using just two of the three dice to create the highest score to nine.

Whenever a player places a wager on Baccarat—the next roll of dice will be deemed to be the player's score. For example if the dice roll is 6-2-1—the player's score is 8. The next roll of the dice determines the house hand.

The following games all utilize a custom deck or multiple decks with each consisting of 48 cards, two suits, circles and squares, and of 8 sets of ace, through to six. Of these, four sets will form one suit (circles) and four sets another suit (squares), the trademark name of the deck is Deck O'Dice. This deck not only allows for a variety of unique games, but can also be used to replace dice rolls in games in which dice are used to determine a player's turn to move.

Card-Gammon

By introducing the Deck O'Dice to the game of backgammon and eradicating the use of dice, Backgammon can be played to various levels of skill. Players are dealt a predetermined number of cards from two upwards. From these, players use any two cards to move their pieces. In the following example, 6 cards are dealt to each player. In effect, giving them their three next moves. This would allow a more skillful strategy to be applied.

Once players have used all their cards, a further six cards are dealt to each player and so on, until one player has won and the game is over. The doubling cube would come into play before each new deal of cards. The more cards dealt to players, the higher the skill level. Players may have the option to either play with each player's card hidden from their opponent, or with all cards face open.

To choose cards in turn from a random selection to begin. In the above example, 12 cards will be randomly selected from the deck of 48. Players then take turn to choose one card until each player has chosen six cards each. Since there is an advantage to the player choosing first, the player choosing second would be first to play. This process is repeated after every turns.

In regards to doubles, it may be best that only cards of the same suit would count as a double move. Therefore, a player holding two cards of six, six, that player may move two pieces if it's an unsuited six, six or move four pieces if the six, six, are of the same suit. This rule will require strategy from players if players choose their six cards from the twelve options.

Another option is for players to be dealt four cards, chose two for their first move, and then draw two more before their next move. This process continues until a winner is determined. Another option is for players to be dealt three cards each and to then choose two for their move and either keep one and then draw two, or play two and discard the remaining card. This process continues until the game is over. The overall effect is that backgammon is played to its exact rules, apart from cards replacing dice rolls in a number of different formats.

The above method could apply to the game of Monopoly and other board games. In the case of Monopoly, the game can be transformed by offering a more skillful version to players. Again, the more cards dealt to players, the higher level of skill.

More randomness could be introduced by having an odd number of cards dealt to the players. If five cards are dealt instead of six, players will need to draw one more card in order to complete their third move. The same format could be used for Card-Gammon.

Felt/Casino Games

Turbo/Speed Poker 3

TP3 has one enforced wager called an ante and an optional wager on the Points Plus wager. After being dealt three cards to each player and the dealer, the player has the option to fold and lose the ante wager, or play by matching the ante wager. It is then a showdown between the player and dealer with the best hand winning. For the dealer to qualify, a minimum poker hand must be achieved. For example, the dealer must have at least Ace-five high from the three cards. If the dealer does not, the player is paid one for one on the ante only. The play wager is returned.

The Points Plus wager is based solely on the player's three cards and will pay according to a selected pay table. This is an example table.

Trips=10:1

Straight Flush=3:1

Straight=3:2

Flush=1:1

All others lose

House edge 4.26%

Poker-Jack11

Players place two matching wagers in a showdown versus the dealer. One wager is for a blackjack hand closest to eleven, the second wager on a two-card poker hand. Players and dealer are dealt three cards from the Deck O'Dice deck. Player then must choose two of the three cards that will combine the best poker hand and the best blackjack hand. The remaining card is discarded. The dealer must prioritize the best blackjack hand on a total of seven or eight depending on the final math. If the dealer cannot reach that mark, the dealer must prioritize the best poker hand.

Optional wager for the player is for the three cards to pay according to a pay table. One possible pay table would offer the following payouts.

Trips=10:1

Straight Flush=3:1

Straight=3:2

Flush=1:1

All others lose

House edge 4.26%

Hold'em 5/Texas 5

This is a multi-player poker version for either tournaments or cash games. Two cards are dealt to each player that are then used to create the best five-card poker hand by combining three community cards. By using the Deck O'Dice deck, it offers a variety of options in how the betting structure is applied. The more betting options, the more skill applied.

Version One

In this version, all players ante before being dealt their two cards. Players then have one simple option—to either double the wager and play or fold. Player will need to consider the following in making their decision.

Once all wagers have been made, players will reveal their two cards and a community flop of three cards is dealt. The best hand will win all wagers. It is important however to note that players will be risking more than their original wager as bonuses will be paid to the winner depending on the ranking of the winning hand.

With this deck containing eight of each card, the biggest bonus maybe paid on five-of a-kind, followed a number of other high-ranking hands such as a straight flush, four-of-a kind, straight, flush and three-of-a-kind.

Players will therefore need to be selective and play hands that are more likely to make a high-ranking hand. For example, any pair, any suited two cards, any two straight cards. The object is to ensure that play is less stressful and that the game is fun and enjoyable to play.

Version Two

By not including the bonus payouts, and by introducing rounds of betting, Texas 5 could be played to the standard hold'em format. A number of options are offered and they include one, two three or four rounds of betting. This number would be dependent on how many community cards are dealt on the flop. This could range between one and three.

Version Three

Due to having double the number of cards represented, for example, eight aces instead of four, the betting structure may be adjusted in order to find the perfect format. One way is to limit the size of the wager. Another is for players to make a single wager based on their starting hand.

Version Four—Video Poker

Hold'em 5 is ideal as a player v electronic on a video poker cabinet. The dealer would play to fixed strategy in terms of when raise, call or fold. Apart from a showdown between player and dealer—bonuses would be paid on the ranking of the five-card poker. The player would therefore have an option as to the stakes for the showdown and the size of the bonuses.

Joker Poker 5

Players place an ante and are dealt two cards face up from the Deck O'Dice deck. Single deck or multiple decks can be used. Based on those two cards, players must decide to either play by matching the ante wager, or fold and lose the ante wager. The object of the game is to create the best five-card poker hand by being dealt a further two cards and by using a mythical joker. It is then a showdown between player and dealer with best five-card poker winning.

In order for the showdown to take place, the dealer must qualify with a minimum hand. This is will be dependent on the final math but it will be three-of-a-kind. For example, 3-3-3. If the dealer fails to qualify, the players win one for one on the ante and the play wager is returned

An optional wager is offered to players that is placed prior to any cards being dealt and is based on the players first two cards. Winnings will be paid according to the Points Plus pay table below.

Points+side bet pays on any two-card straight flush, or a total of 10 or more. All cards count as face value.

Total of 12=10:1

Total of 11=5:1 if it's 6-5 suited, 2:1 otherwise

Total of 10=3:2

Other straight flushes (A2, 23, 34, 45 suited)=1:1

All others lose

Points+−optional pay table

This pay table would again be based on the player's first two cards and would pay on pairs, suited pairs and two card straight flushes.

Joker Poker 4

Players place an ante and are dealt two cards face up from the Deck O'Dice deck. Single deck or multiple decks can be used. Based on those two cards, players must decide to either play by matching the ante wager, or fold and lose the ante wager. The object of the game is to create the best four-card poker hand by being dealt a further one card and by using a mythical joker. It is then a showdown between player and dealer with best four-card poker winning.

In order for the showdown to take place, the dealer must qualify with a minimum hand. This is will be dependent on the final math for example Aces plus. If the dealer fails to qualify, the players win one for one on the ante and the play wager is returned.

An optional wager is offered to players that is placed prior to any cards being dealt and is based on the players first two cards. Winnings will be paid according to the Points Plus pay table below. Points Plus side bet pays on any two-card straight flush, or a total of 10 or more, Cards count at face value.

Total of 12=10:1

Total of 11=5:1 if it's 6-5 suited, 2:1 otherwise

Total of 10=3:2

Straight flushes (A2, 23, 34, 45 suited)=1:1

All others lose

Points+−optional pay table

This pay table would again be based on the player's first two cards and would pay on pairs, suited pairs and two card straight flushes.

Version Four—Video Poker

Hold'em 4 is ideal as a player v electronic on a video poker cabinet. The dealer would play to a fixed strategy in terms of when raise, call or fold. Apart from a showdown between player and dealer—bonuses would be paid on the ranking of the five-card poker. The player would therefore have an option as to the stakes for the showdown and the size of the bonuses.

Overall Benefits and Options of Deck O'Dice

Deck O'Dice provides an opportunity to take games to a new level in terms simplicity and uniqueness, as well as transforming strategy with games using dice.

Custom Card Deck

This next grouping of games offers three unique introductions to the gaming industry. First, it offers a custom deck of cards, which generates a wide variety of innovative games, pro wagers and unique pay tables.

Second, it offers a method or system in which multiple games can be offered and in which the outcome to all the games, paytables and prop wagers, are determined by one deal of the cards and in which the deal determines the outcome to every game and wager. In some games, the dealer does not require a hand. In instances when the player is playing against the dealer, the player's hand will begin from left to right and the dealer's hand will begin from right to left. In some cases, player and dealer may share a card or cards from the community deal.

The number of cards in the deal will vary from one upwards to ten or more. The games described in this application will focus on five or six cards. Some games are classed as skill-based, while others are based on probabilities.

This method has numerous benefits to players and to an industry constantly looking for innovation. For the player, games are engaging and would cater to every demographic in one location, one system, or one application and on one deal. For the industry, it will cut down on costs and increase profits through the method/system catering to most of the popular games as well as novel games through one dealer.

Currently, a live dealer is required for individual games and games offered on the casino floor or through live streaming. The disclosed method/system allows one dealer, either on the casino floor or through live streaming, to cater to players and cover most games with one single deal; saving on manpower and system costs.

The third unique introductions to the gaming industry, is that in certain cases and certain markets, games offered through a Random Number Generator (RNG) are not as popular due to mistrust in the randomness of an RNG. For example, one such market is Asia in which there is a dislike of RNGs. Due to how the RNG determines the outcome to every game included in the system, any mistrust in the RNG would be totally groundless. As such, markets such as Asia, and individual players, will be more likely to embrace the disclosed system.

The following games all utilize a custom deck of cards comprised of eights sets of ace through six, with two suits and two colors, red circles and black squares. Suits play a role in some of the games, but six-sided dice can be used instead of cards. In some embodiments, a striped deck with only ace through six applies, and all flush and suited rules apply to colors irrespective of the suits described.

Game play is flexible, but the following format allows for an outcome to numerous games from a deal of two, three, four, five, six cards or more from the custom deck or striped deck and, for the games to be offered through a live dealer, automated or digital devices and through random dealing or with an Random Number Generator. In all poker games, six is highest and ace lowest and in all other games, the pip count is valued at face value with ace counting as one and six counting as six.

The Games

The games disclosed herein are Baccarat, Baccarat—skill version, Trio-Card Poker, Three and/or five Card Sic Bo, Craps, Lucky Pairs, One-Card Poker, Suited Craps, Hi-Lo Twister, Blackjack, and Joker-Poker.

The Deal

The outcomes for all games disclosed herein are determined by the order in which the community cards are dealt. The player's cards play a role from left to right and will utilize either the first two, first three, first four, or every card in the community deal. The dealer's cards, when applicable, will be formed from right to left, be it two cards or more.

The first two cards will apply to a selection of games including craps and suited craps, as well as baccarat and Joker Poker. The first three cards will form the player's hand for baccarat and three-card poker. The dealer's hands for Trio-Card Poker and Baccarat will be formed by the 3^{rd}, 4^{th} and 5^{th} cards if five cards are dealt—meaning that the player and dealer share the third card or, from the 4th, 5th and 6th cards if a six card community board is dealt.

Baccarat

The object is to create a baccarat score closest to nine by combining two from three cards of the dice deck. In a preferred embodiment, a suited score beats an unsuited score of equal value. In cases when a dealer or player cannot score nine or less, the game is deemed to be a bust. For example, if 6, 6, 6 or 5, 5, 5 is dealt, the game is a bust.

To play, players place a wager and the first three cards of the deal will form the player's hand. From those three cards, two cards must be used to create the highest score closest to nine. The dealer's baccarat hand is formed from the last three cards of the community deal. A bonus payout of 3/2 or 6/5 may apply to players who have a suited nine (6-3 and 5-4) from the first two cards.

Baccarat Skill Version

In this version, when the players first two cards score six or seven, the player has the option to stick and not utilize the third card. This will allow for a bonus payout should the hand beats the dealer's hand. The bonus payout will be determined by the final math but, as an example, a score of six may pay 3/1, and a score of seven may pay 2/1.

Optional Wagers for Both Baccarat Versions

Optional wagers for both Baccarat versions include a bust insurance paying 20/1, a poker paytable based on a player's first three cards, a points paytable total based on players first three cards or all five or six cards from the deal, a tie paytable offering different payouts for different ties, a wager on a player's first two cards forming a suited nine (6-3 or 5-4), and a progressive jackpot when player and dealer tie on a suited score of two points. In effect, this will require the deal of five or six cards to consist of five or six aces of the same suit.

Lucky Pairs

In one embodiment of Lucky Pairs, players have six wagering cards: ace, two, three, four, five, and six, and players may place a wager on any of the six cards. These wagers can win when a pair is dealt from the first five community cards if six cards are dealt, or the wagers can win when a pair is dealt from all five community cards if five cards are dealt. For example, if the deal of five cards is 2, 2, 3, 4, 5, all wagers placed on wagering card two will win.

The amount of return can be determined by the final math, but, in a preferred embodiment, will be between 4/1 and 5/1. If the five cards form two pairs, for example, 2, 2, 3, 3, 6, then wagers on the two and three will win. A deal of five cards will form a pair roughly 70% of the time. However, when the five cards form three-of-a-kind (trips), all wagers on the six wagering cards lose. Trips form five cards are dealt just under 16% of the time.

Another way to offer wagering on pairs is to create a number of groups. For example, group (a) pairs of 1-2, group (b) pairs of 3-4, and group (c) pairs of 5-6. Therefore, if the deal is 1, 1, 3, 4, 5, group A wins and other two groups lose. If the deal is 1, 1, 3, 3, 4, group A and group B win, and group C loses. If the deal is 1, 1, 2, 2, 5, group A wins, and a bonus payout will apply for the same group being deal two pairs. The same applies to any of the three groups being dealt two pairs. For example, if the deal is 3, 3, 4, 4, 6, group B wins and receives a bonus payout, and if the deal is 5, 5, 6, 6, 1, group C wins and receives a bonus payout.

A further way to offer wagering to players is to create two groups of three. For example, group (a) is 1-2-3 and group (b) is 4-5-6. Again, a group being dealt a pair would win and the group without a pair would lose. For example, if 1, 2, 2, 3, 5 is dealt, group (a) wins and group (b) loses. In some embodiments, both groups could win if both are dealt a pair. For example, when the deal is 1, 1, 4, 4, 5 or 2, 2, 3, 6, 6. Similar to wagering on pairs of a group, a bonus payout will apply if any group is dealt two pairs. For example, a deal of 1, 1, 3, 3, 4 or 4, 4, 5, 5, 2, will result in a payout to the respective group. A “no pair” wager may also be offered, wherein a player can wager that no pair will be dealt on the community board of five cards. Further, a “trio” wager may also be offered, wherein a player can wager that three-of-a-kind will be dealt on the community board of five cards.

Bonus Payouts

Bonus payouts may apply when four or five-of-a-kind is dealt. For example, if 2, 2, 2, 2, 4 is dealt, a player who wagers on the two would receive a bonus payout. The same applies for five-of-a-kind.

Optional Wagers for Lucky Pairs

Optional wager for Lucky Pairs include a progressive jackpot for a suited 6, 6, 6, 6, 6, a paytable for five card poker and for a five-card points score.

Craps

The disclosed version of craps has a variety of possible formats. In a first possible format, players can place a wager before the community deal, and the first two cards will form the point. Therefore, the effect is a come out roll. At this stage and after the first cards are dealt, the dealer can pause in order to allow craps wagers to be placed.

The dealer can then deal one more card and pause if the three-card poker game is offered as one of the options. If poker is not included as one of the options, the dealer can deal two cards instead of one, as third and fourth cards can also apply to craps. The fifth and sixth cards can then be dealt, and the outcome to all games can be determined.

Suited Craps

With suited craps, when a point is established, irrespective of the suits of the two cards that formed the point, all wagers can only win or lose from suited outcomes. This means that all wagers on the box numbers of 4, 5, 6, 8, 9, 10 (excluding the number forming the point) will only be paid when that number is formed from two cards of the same suite and/or color. The same can also apply to making the point and with a seven-out.

All other wagers made after the point has been established or before a come out roll will pay accordingly without color or suit being relevant to the outcome, excluded pass and don't pass wagers.

The feature described herein would slow down the ratio of winning and losing wagers in normal circumstances. With Suited Craps, however, this feature is deemed as favorable due to the speed and possible high number of crap “hands” or “rolls” contained within this unique system. For example, with a six-card community and the above system, it is possible to combine the deal to create 2, 3, 4, 5, and 6 combinations of the two cards required to create a craps hand.

Suited Craps enhance craps further by offering greater odds and options for one-roll wagers such aces, sixes and hop bets. Furthermore, players will be able to play craps at the beginning of each and every deal. In effect, a number of players may be playing craps and sharing a community deal but each player will be playing independently. Therefore, no matter the number of players playing craps, all could be playing to a different sequence from the deal, have established different points, and be at various stages of a game.

Points Poker (a Five-Card Version of Sic Bo)

Points Poker allows a variety of wagers to be placed based on the points score of the five-cards or on a five-card poker ranking. For example, a player can place wagers on high and low, groups of numbers, and an individual number. Suits-based wagers may also apply in terms of the payouts, and they may offer greater odds. Further, a paytable may also be offered based on poker hand ranking or on point scores that are based on the pip value of the cards. In one embodiment, each card from ace to six is counted at face value, with ace being the lowest and six the highest in both points value and poker rankings.

An example pay table on poker is five of a kind suited, five of a kind, straight flush, four of a kind suited, four of a kind, full house, three-of a kind, two pair, and no pair/high card. An example pay table based on points score with each dice counting at face value is as follows:

| Points | Winnings |
|---|---|
| 30, 29, 28, 27, or 26 points | 12/1 |
| 3, 4, 5, 6, or 7 points | 12/1 |
| 20 through 25 point | 6/1 |
| 8 through 12 points | 6/1 |
| 13 through 16 points | 5/1 |
| All others lose | 0 |

One-Card Poker

One-card poker offers six wagering cards, ace thru to six, with six being highest ranked and ace lowest ranked. In some embodiments, the wagering cards can offer different odds, and the final odds may be determined by the math. For example, a six can offer 7 for 2, a five can offer 4 for 1, a four can offer a 9 for 2, a three can offer 5 for 1, a two can offer 8 for 1, and a 1 can offer 10 for 1. Players may place a wager on one or more of the above six wagering cards

Rules

One of the six wagering cards will be added to the community deal to form the best possible poker hand, be it a poker hand consisting of three cards, four cards, five cards or more. All wagering cards represent both suits. More specifically, in a five-card poker hand, if the deal contains four of one suit, the six will always be used to form a flush, even if the six forms part of the deal. For example, if the four cards are 6, 4, 2, 2 of the same suit, then the six from the wagering cards will be used to create the highest flush. If the deal contained 6, 5, 4, 3 of the same suit, the two from the wagering cards will be used to create a royal or straight flush. Irrespective, the winning wagering card will be determined by the hand rankings for five-card poker.

The following are examples for six-card poker in which five community cards are added to by one of the wagering cards. If the deal is 5, 5, 6, 3, 2, then the wagering card five is the winner. If the deal is 1, 1, 5, 6, 4, then the wagering card ace is the winner. If the deal is 1, 2, 3, 4, 5, then the wagering card six is the winner. If the deal is 2, 3, 4, 5, 6, then the wagering card ace is the winner.

Optional Wagers for One-Card Poker

Optional wagers for One-Card Poker include a five or six-card poker paytable or a six-card points paytable.

Exacta and Trifecta Wagers

An exacta is predicting which of the six wagering cards forms the best poker hand, and which wagering card forms the second best six-card poker hand. For example, if the five cards dealt are 6, 6, 3, 4, 5, a six would form the best hand and a five would form the second best hand, making two pair of sixes and fives. A trifecta wager would look to predict the best three poker hands in a correct order. In the above example, a six is best, a five is second best, and a four would form the third best hand.

Trio-Card Poker

In a preferred embodiment, players place an ante before the deal of the first three cards. Based on the strength of those three cards, player may choose to forfeit the ante, or raise by making a second wager. A three-card bonus wager is optional and would pay various odds from a paytable. Additionally, the dealer's three-card hand would consist of either the final three cards if six cards are being dealt. However, if five cards are being dealt, the dealer's three-card hand would consist of the third, fourth and fifth cards.

Six-Card Deal

The above games can also be offered by dealing a community board of six cards or more, as each game will only include the number of cards required. Therefore, for a six-card deal, the format described below could apply.

Depending on the games to be included into the system, the dealer can deal either two or three cards, pause for any wagers, and then deal the remaining three cards. The dealer can deal two cards for craps, pause for any wagers, and then deal two more cards and pause.

Hi-Lo Twister

In some embodiments of Hi-Lo Twister, players place a compulsory wager before the deal, and the outcome is determined by how many winning “hands” will be generated in sequence by either a five- or six-card deal. A winning hand in this case is determined by the pip count or value of each card in the deal and the sequence dealt. A winning hand would entail the second card being higher or lower than the first card. For the second card to be higher, the first card would need to be an ace, two or three. For the second card to be lower, the first card must be a four, five or six.

In order for the wager to win, a player must form a number of winning hands in sequence. The number of cards in a community deal and the final math can determine this number. For example, a winning sequence of three or four winning hands is possible from a five-card deal. In another example, a winning sequence of three, four, or five winning hands is possible from a six-card deal. The number of wins will vary if seven or more cards are dealt.

The initial wager may pay a variety of odds depending on the number of winning hands during one or more deals. For example, a six-card deal would allow a maximum of five winning hands in sequence. A deal of five cards will allow for a winning sequence of four. An optional “All the Way” wager will pay according to the number of winning hands in sequence. If the last three, four, or five hands are winning hands, this wager will extend to the next deal until a maximum number of hands have been won. Depending on the math, this figure is expected to be between ten and fifteen.

Joker Poker

In some embodiments, a deal of six cards is played if the player and dealer share the third card from deal. More specifically, the rules of the game are as follows. Players place an ante before the deal, the first two cards dealt are deemed to be the player's hand, and based on the strength of the two cards, the player must decide if he or she should play/raise by adding a further wager or forfeiting the ante. If the player continues to play, the following two cards of the deal complete the player's poker hand. A joker is then added to form the best five-card hand.

An optional bonus wager may also be offered. The payout may be from a paytable and may offer different odds based on the hand ranking, which can include a selection of poker hands that include the joker: suited and unsuited five-of-a-kind, royal flush, suited and unsuited full house, etc. The strategy for players is simple as it is advised to play/raise with every suited or connected two cards and all pairs. A progressive jackpot may apply for a suited 6, 6, 6, 6, joker.

Blackjack 11

The object is to score a points total closest to eleven from a maximum of four cards. Blackjack in this case is 6, 5 both suited and unsuited with unsuited paying 6 for 5 and suited paying 6 for 4, depending on the final math.

Players can place a wager and, from the community deal of six cards, the first two cards will be the player's hand. Splits are not allowed except if a player receives a deal of 6, 6, with players receiving just one card on each. These will be 3rd and 4th cards from the deal. Depending on the final math, a player being dealt another six when splitting can be a push or a bust.

Based on the first two cards, players may draw a maximum of two or more cards with the third and fourth cards from the deal as the additions to the player's hand. The dealer's hand will consist of the fifth and sixth cards, with the dealer playing the third and fourth. In effect, the six cards are dealt in sequence with the player's cards being from left to right and the dealer's cards from right to left.

If the math allows, a player scoring under from the first four cards may count as a push, and a bonus payout is available for the players if the first four cards are four aces. A progressive jackpot may apply if the player and dealer tie on a points total of four (four aces) or eight (four deuces). In effect, a progressive jackpot will require six aces to be dealt or six deuces. The above may apply to suited or unsuited ties.

Pick Three

Pick Three allows players to pick three of the six cards possible, from ace through to six, that they predict will form part of the deal. The following are example payouts and are dependent on the final math.

| Cards | Winnings |
|---|---|
| 4 from 6 | 3/2 |
| 5 from 6 | 2/1 |
| 6 from 6 | 3/1 |

Higher odds will apply if any of the above forms two pairs, three pairs, three of a kind, and two sets of three of a kind.

Pick Two

The object is to pick two of the six cards a player predicts will form part of the deal. The more times those two cards appear on the deal, the higher the payout to the player. Some example odds are as follows.

| Cards | Winnings |
|---|---|
| Three cards on the deal | 1/1 |
| Four cards on the deal | 2/1 |
| Five cards on the deal | 4/1 |
| Six cards on the deal | 10/1 |

Prop Wagers, Option Bonus Wagers and Jackpots

The following optional wagers and progressive jackpots can apply to one specific game, a combination of games, or can be all-inclusive across the board. The following could be offered with either a five- or six-card community deal. The following examples, however, are all based on a six-card deal.

Hop Wagers

A variety of wagers can apply to suited pairs, such red sixes, black fives, or black sixes and red fives, the suited pairs being dealt in any order of the deal or being specific to each pair of cards. For example, if the suited pairs are specific to each pair of dealt cards, possible chances are created from the first two cards together, the third and fourth cards together, or the fifth and sixth cards together.

A hop wager can be expanded to include a paytable based on more than one deal, with different odds offered depending on the number of suited pairs accumulated during the number of deals applied. For example, if the wager applies to five deals, there are thirty cards in total, a possible 15 suited pairs total, and a maximum of three suited pairs with each deal. If three of the same suited are dealt during one deal, it will only count as one suited pair. An example paytable for one unit is as follows.

| Cards | Winnings |
|---|---|
| 12 suited pairs | 100 |
| 11 suited pairs | 50 |
| 10 suited pairs | 35 |
| 9 suited pairs | 30 |
| 8 suited pairs | 20 |
| 7 suited pairs | 12 |
| 6 suited pairs | 10 |
| 5 suited pairs | 5 |
| 4 suited pairs | 3 |

A second paytable could apply for unsuited pairs but with reduced odds on offer. There is also the option to increase the number of deals for each wager, meaning that the odds or payouts will adjust accordingly. The more deals included in the wager, the fewer odds that would apply.

Trio's Galore

This optional wager can also pay various odds for a number of trio's or three-of-a-kind dealt within a selected number of deals. For example, ten deals of six cards would allow for 20 trio's to be dealt. A Trio paytable could therefore offer the following example odds, with each payout applying to one unit.

| Trios | Payout |
|---|---|
| 13 Trios | 100 |
| 12 Trios | 66 |
| 11 Trios | 50 |
| 10 Trios | 35 |
| 9 Trios | 25 |
| 8 Trios | 20 |
| 7 Trios | 12 |
| 6 Trios | 8 |
| 5 Trios | 2 |

A four-of-a-kind wager could also apply and pay different odds depending on the number of deals it takes to be dealt. An example paytable could be the following, with each payout based on one unit.

| Deals | Payout |
|---|---|
| 1 deal | 50 |
| 2 deals | 35 |
| 3 deals | 30 |
| 4 deals | 20 |
| 5 deals | 10 |
| 6 deals | 5 |
| 8 deals | 3 |
| 9 deals | 2 |

Flop A Flush

This paytable may require all six cards of the same suit to be dealt on deal, and the odds would be dependent on the number of deals before a flush is dealt. Example odds are to one unit.

| Deals | Payout |
|---|---|
| Flush in 1 deal | 12 |
| Flush in 2 deals | 8 |
| Flush in 3 deals | 5 |
| Flush in 4 deals | 3 |
| Flush in 5 deals | 2 |
| Flush in six deals | 1 |

Standard Deck

The same method can apply to dealing with a standard deck of 52 cards with the following games.

Blackjack

In one embodiment, players place a wager, and the first two cards of the deal are the player's starting hand. Players may only split in instances when they can receive only one card on each split hand. The maximum number of cards both players and dealer can use from the community deal will be four.

Whereas the player's hand begin left to right, the dealer's hand will begin right to left, meaning that both player and dealer may share 3rd and 4th cards from the deal. Irrespective of the number of cards used by both player and dealer, the deal may be in sequence beginning from left to right for the player and right to left for the dealer.

Baccarat

In this game, players can first place a wager and then form their baccarat hand from the first three cards. The dealer will form a baccarat hand from the fourth, fifth, and sixth cards.

One-Card Poker

In this version, there are thirteen wagering cards from deuce through an ace, with a deuce lowest and ace highest. Players may place a wager on one or more wagering cards. The odds will vary with ace offering the shortest odds and deuce offering the highest odds. For example, an ace may offers 8/1 and a deuce 80/1. Each wagering cards represent all four suits.

From the community deal, four cards will be used and combined with the one wagering card to form the best five-card poker hand. For example, if the community deal is ace, six, queen, five, four and king, the ace wagering card will be used to form a pair of aces. In another example, if the deal is ace, six, queen, four, four, king, then it will be the four wagering card that will be used to make three-of-a-kind.

In any deal when there are four cards of the same suit, the next highest card from the wagering cards will be used to form the best flush. For example, if ace is the highest card followed by a queen, then the King wagering card will determine the best hand. In instances when four cards of the same suit are also in sequence, for example, 4-5-6-7, the wagering card eight will be the winning card.

Craps

When using a standard 52-card deck, only cards from ace through to six form any one deal and do not carry forward to the next deal. If two cards of six and under form part of the deal, then these two would count toward any craps wager. If three cards of six and under form part of the deal, then only the first two cards will count for craps.

When four such low cards form part of the deal, the first two will combine and count towards craps wagers and the last two will combine and count towards craps wagers. If five cards of six and under are dealt, then only the first four cards count towards craps, with the first two such cards combing for a first pair and the following two cards combing for a second pair. If six such low cards are dealt, then there will be three craps wagers with the first two combining, the second two combining, and the final two combining.

Flushes

A variety of wagers can be offered based on how many cards form a flush from two to six as well how many sets of flushes form one or more deals. For example, on a single deal, players may wager on how many two-card, three-card, four-card, five-card or six-card flushes will be dealt. All odds will be determined by the final math. The following are example odds and paytables.

| Cards | Payout |
|---|---|
| 3-card flush | 1/1 |
| 4-card flush | 2/1 |
| 5-card flush | 5/1 |
| 6-card flush | 25/1 |
| 3-card straight flush | 12/1 |
| 4-card straight flush | 40/1 |
| 5-card straight flush | 100/1 |
| 6-card straight flush | Jackpot |

Straights

A similar paytable may apply for straights of 3, 4, 5 or 6 cards.

Hi-Lo Twister

The game described above based on the custom deck can also apply to a standard deck with any card under eight needing a higher card to continue the sequence and any card over eight needing to go lower.

Points Poker

All cards from deuce up to and including ten count at face value with jack counting eleven, queen counting twelve, king counting thirteen, and ace counting fourteen. A wide variety of wagers can be offered based on the total value of the community board.

Two-Card War

Players place an ante and use the first two cards of the community deal in what will be a two-card race against the dealer. Based on those two cards, players can decide to play by making a further wager or players can choose to forfeit the ante.

The last two cards dealt from the community deal create the dealer's hand in this case. The two races are between the first two cards and the final two cards, with the player's first race starting from the left (the first card of the deal) and the dealer's race starting from the right (the last card dealt).

A bonus may be paid for a player winning both races with a pair and, depending on the final math, the dealer may win all ties. In one embodiment, a player must win both races to win the wager and must lose both races to lose the wager.

Pick a Card

Players can place a wager on any of the thirteen cards to form part of the deal. A bonus payout would apply if the card forms a pair, three-of-kind, or four-of a kind. The odds on all payouts may be determined by the final math.

Multi-Game Wagering System

The system offers four unique introductions to the gaming industry.

First, the system offers a custom deck of card that generates a wide variety of innovative games, pro wagers, and unique pay tables.

Second, the system offers a method or system in which multiple games can be offered and in which the outcome to all the games, paytables and prop wagers, are determined by one deal of the cards, and in which the deal determines the outcome to every game and wager. In some games, the dealer does not require a hand. In instances when the player is playing against the dealer, the player's hand will begin from left to right and the dealer's hand will begin from right to left. In some cases, player and dealer may share a card or cards from the community tent.

The number of cards in the deal will vary from one upwards to ten or more. The games described in this application will focus on five or six cards. Some games are classed as skill while others are simply based on probabilities.

This method has numerous benefits to both players and an industry constantly looking for innovation. For the player, games are engaging and would cater to every demographic in one location, one system or one application and on one deal. For the industry, it will cut down on costs and increase profits through the method/system catering to most of the popular games as well as novel games through one dealer.

Currently, a live dealer is required for individual games and applies to games offered on the casino floor or through live streaming. This method/system allows one dealer either on the casino floor or though live streaming, to cater to players and cover most games with one single deal; saving on manpower and system costs.

Third, in certain cases and certain markets, games offered through a Random Number Generator (RNG), are not as popular due to mistrust in the randomness of an RNG. One such market being Asia in which there is a dislike to the RNG. Due to how the RNG determines the outcome to every game included in the system, any mistrust in the RNG would be totally groundless. As such, markets such as Asia will be more likely to embrace the system as would individual players.

Fourth, parlays, meaning wagering on more than one outcome, be one two or more, are popular in sports betting but this system and method would allow for parlays to become an integral part of gaming. The opportunity for large returns by placing small wagers with small wagers will prove extremely attractive to players as well as allowing players to simple wager on outcomes without needing to make any decisions on the selected outcomes.

The following games all utilize a custom deck of cards comprised of eights sets of ace through to six, with two suits and two colors, red circles and black squares. Suites play a role in some of the games but six-sided dice can be used instead of cards. A stripped deck with only ace though to six can apply and all flush and suited rules would apply to colors irrespective of the suits described.

Game play is flexible but the following format allows for an outcome to numerous games from a deal of two, three, four five, six cards or more from the custom or stripped deck and, for the games to be offered through a live dealer, automated or digital devices and through random dealing or with an Random Number Generator.

In all poker games, six is highest and ace lowest and in all other games, the pip count is valued at face value with ace counting as one and six counting as six. The following games are just a selection of the possible games that could be implemented into the system: Baccarat, Baccarat—skill version, Trio-Card Poker, Three and/or five Card Sic Bo, Craps, Lucky Pairs, One-Card Poker, Suited Craps, Hi-Lo Twister, Blackjack, and Joker-Poker.

The Deal

The outcome for all the games are determined by the order in which the community cards are dealt. The player's cards play a role from left to right and will utilize either the first two, first three, first four or all every card in the community deal. The dealer's cards, when applicable, will be formed from right to left, be it two cards or more.

The first two cards will apply to a selection of games including both craps and suited craps as well as baccarat and Joker Poker. The first three cards will form the player's hand for both baccarat and three-card poker. The dealer's hands for Trio-Card Poker and Baccarat will be formed by the 3rd, 4th and 5th cards if five cards are dealt—meaning that the player and dealer share the third card or, from the 4th, 5th and 6th cards if a six card community board is dealt.

Baccarat

The object is to create a baccarat score closest to nine by combining two from three cards of the dice deck. A suited score beats an unsuited score of equal value. In cases when dealer or player cannot score nine or under, it is deemed to be a bust. For example, 6-6-6 or 5-5-5.

After players place a wager, the first three cards of the deal will form the player's hand. From those three cards, two cards must be used to create the highest score closest to nine. The dealer's baccarat hand is formed from the last three cards of the community deal. A bonus payout of 3/2 or 6/5 may apply to players for a suited nine (6-3 and 5-4) from the first two cards.

Baccarat Skill Version

In this version, when the players first two cards score six or seven the player has the option to stick and not utilize the third card. This will allow for a bonus payout should the hand beats the dealer's hand. The bonus payout will be determined by the final math but as an example, For example, a score of six may pay 3/1, a score of seven, 2/1.

Optional wagers for both Baccarat versions include: Bust insurance—pays about 20/1; A poker paytable based on a player's first three cards; A points paytable total based on players first three cards or all five or six cards from the deal; A tie paytable offering different payouts for different ties; A progressive jackpot when player and dealer tie on a suited score of two points, which will require the deal of five or six cards to consist of five or six aces of the same suit; An optional wager on a player's first two cards forming a suited nine (6-3 or 5-4).

Lucky Pairs

Players have six wagering cards, ace, two, three, four, five and six. Players may place a wager on any of the six cards. These wagers will win when a pair is dealt from the deal of the first five community cards if six cards are dealt or all five community cards if five cards are dealt. For example, if the deal of five cards is, 2, 2, 3, 4, 5. All wagers placed on wagering card two will win. The amount of return will be determined by the final math but it will be between 4/1 and 5/1.

If the five cards form two pairs, for example, 2, 2, 3, 3, 6 —then wagers on the two and three will win. A deal of five cards will form a pair roughly 70% of the time. When the five cards form three-of-a-kind (trips), all wagers on the six wagering cards lose. Trips from five cards are dealt just under 16% of the time. Another way to offer wagering on pairs is to create a number of groups, as follows:

Group (a) pairs of 1-2

Group (b) pairs of 3-4

Group (c) pairs of 5-6

If the deal is 11345—group A win and other two groups lose. If the deal is 11334—group A and Group B and group C loses. If the deal is 1122×—Group A wins and a bonus payout will apply for the same group being deal two pairs. The same applies to any of the three groups being dealt two pairs. For example, 33446 and 55661.

A further wager is to offer two groups of three, such as:

Group (a) 1-2-3

Group (b) 4-5-6

Again, a group being dealt a pair would win and the group without a pair would lose. Both groups could win if both are dealt a pair. For example, when the deal is 11445 or 22366. A bonus payout will apply if any group is dealt two pairs. For example, 11334 or 44552.

A “no pair” wager may also be offered. Meaning that no pair will be dealt on the community board of five cards. A “trio” wager may also offered. Meaning that three-of-a-kind will be dealt on the community board of five cards. Bonus payouts may apply when four or five-of-a-kind is dealt. For example, 2, 2, 2, 2, 4. In this case, wagers on the two would receive a bonus payout. The same applies for five-of-kind.

The following are optional wagers for Lucky Pairs: A progressive jackpot for a suited 6-6-6-6-6; A paytable for both five card poker and for a five-card points score.

Craps

This version of craps has a variety of possible formats. The first will see players place a wager before the community deal. The first two cards will form the point. In effect, the first two cards operate as the come out roll. At this stage and after the first cards are dealt, the dealer will pause in order to allow craps wagers to be placed. The dealer will then deal one more card and will need to pause if the three-card poker game is offered as one of the options. If poker is not included as one of the options, the dealer will deal two cards instead as third and fourth cards can also apply to craps. The fifth and sixth cards are then dealt and the outcome to all games are determined.

Suited Craps

With suited craps, when a point is established, irrespective of the suits of the two cards that formed the point; all wagers will only win or lose from suited outcomes. This means that all wagers on the box numbers of, 4, 5, 6, 8, 9. 10 (excluding the number forming the point) will only be paid when that number is formed from two cards of the same suite and/or color.

The same also applies to making the point and with a seven-out. All other wagers made after the point has been established or before a come out roll will pay accordingly without color or suit being relevant to the outcome, excluding pass and don't pass wagers.

The feature would slow down the ratio of winning and losing wagers in normal circumstances. With Suited Craps, however, this feature is deemed as favorable due to the speed and possible high number of crap “hands” or “rolls” contained within this unique system. For example, with a six-card community and the above system, it is possible to combine the deal to create 2, 3, 4, 5, 6 combinations of the two cards required to create a craps hand.

Suited Craps also enhance craps further by offering greater odds and options for one-roll wagers such aces, sixes and hop bets. Furthermore, players will be able to play craps at the beginning of each and every deal. In effect, a number of players may be playing craps and sharing a community deal but each player will be playing independently. Meaning that no matter the number of players playing craps, all could be playing to a different sequence from the deal, established different points and be at various stages of a game.

Points Poker (a Five-Card Version of Sic Bo)

Points Poker allows a variety of wagers based on the points score of the five-cards or on a five-card poker ranking. For example, wagers on high and low, groups of numbers and individual number. Suits may also apply in terms of the payouts and offer greater odds.

A paytable may also be offered based on either poker hand ranking or point scores based on the pip value of the cards. Each card from ace to six is counted at face value with ace lowest and six highest in both points value and poker rankings. An example pay table on poker is as follows: Five of a kind suited; Five of a kind; Straight flush; Four of a kind suited; Four of a kind; Full house; Three-of a kind; Two pair; No pair.

An example pay table based on points score with each dice counting at face value is as follows:

30 points, 29 points, 28 points, 27 points, 26 points pay 12/1

3 points, 4 points, 5 points, 6 points, 7 points pay 12/1

20 thru 25 pays 6/1

8 thru 12 pays 6/1

13 thru 16 pays 5/1

All others lose

One-Card Poker

One poker offers six wagering cards, ace thru to six, with six being highest ranked and ace lowest rank. The wagering cards offer different odds. For example, the final odds will be determined by the math: 6-7 for 2; 5-4 for 1; 4-9 for 2; 3-5 for 1; 2-8 for 1; 1-10 for 1.

Players may place a wager on one or more of the above six wagering cards. One of the six wagering cards will be added to the community deal to form the best possible poker hand, be it a poker hand consisting of three cards, four card, five cards or more. All wagering cards represent both suits. In a five-card poker hand for example, if the deal contains four of one suit, the six will always be used to form a flush, even if the six forms part of the deal.

For example, of the four cards are 6, 4, 2, 2 of the same suit, then the six wagering cards will be used to create the highest flush. If the deal contained 6, 5, 4, 3 of the same suit, the two from the wagering cards will be used to create a royal or straight flush. Irrespective, the winning wagering card will be determined by the hand rankings for five card poker.

The following are an example for six-card poker in which five community cards are added to by one of the wagering cards. Example deals for six cards: If the deal is 5-5-6-3-2, then wagering card five is winner. If the deal is 1-1-5-6-4, then wagering card ace is the winner. If the deal is 1-2-3-4-5, the wagering card six is the winner. If the deal is 2-3-4-5-6, then wagering card ace is the winner.

Optional wagers for One-card poker include a five or six-card poker paytable or six card points paytable. Exacta and trifecta wagers are also possible, wherein an exacta is predicting which of the six wagering cards forms the best poker hand, and which wagering card forms the second best six-card poker hand. For example, if the five cards deal is as follows: 6, 6, 3, 4, 5—Six would form the best hand and five form the second best hand, making two pair of sixes and fives. A trifecta wager would look to predict the best three poker hands in a correct order. In the above example, six is best followed by five and four would form the third best hand.

Trio-Card Poker

Players place an ante before the deal of the first three cards. Based on the strength of those three cards, player may choose to forfeit the ante, or raise by making a second wager. A three-card bonus wager is optional and would pay various odds from a paytable. The dealer's three-card hand would consist of either the final three cards if the deal is six cards, or the third, fourth and fifth cards if it is a five card deal.

Six-Card Deal

The above games can also be offered by dealing a community board of six cards or more as each game will only include the number of cards required. For a six-card deal, the following format could apply. Depending on the games to be included into the system, the dealer will deal either two or three cards, pause for any wagers and then deal the remaining three cards. Dealer deals two cards for craps, pauses for any wagers and then deals two more cards and pauses.

Hi-Lo Twister

Players place a compulsory wager before the deal. The outcome is determined by how many winning “hands”, will be generated in sequence by either a five or six-card deal. A winning hand in this case is determined the pip count or value of each card in the deal and the sequence dealt. A winning hand would entail the second card being higher or lower than the first card. For the second card to be higher, the first card would need to be an ace, two or three. For the second card to be lower, the first card must be a four, five or six.

In order for the wager to win, a player must form a number of winning hands in sequence. This number will be determined by the number of cards in a community deal and the final math. As an example, a winning sequence of three or four, from a five-card deal or three, four or five from a six-card deal. The number of wins will vary if seven or more cards are dealt.

The initial wager may pay a variety of odds depending on the number of winning hands during one or more deals. For example, a six-card deal would allow a maximum of five winning hands in sequence. A deal of five cards will allow for a winning sequence of four. An optional “All the Way” wager will pay according to the number of winning hands in sequence. If the last three four or five are winning hands, this wager will extent to the next deal until a maximum number of hands have been won. Depending on the math, this figure is expected to be between ten and fifteen.

Joker Poker

A deal of six cards is required to play of five if the player and dealer share the third card from deal. Players place an ante before the deal. The first two cards are deemed to be the player's hand. Based on the strength of the two cards, players must decide if they should play/raise by adding a further wager, or forfeiting the ante. The following two cards of the deal complete the player's poker hand. A joker is then added to form the best five card hand.

An optional bonus wager if also offered. The payout will be from a paytable and offer different odds based on the hand ranking. This will include a selection of poker hands, including the joker—suited and unsuited five-of-a-kind, royal flush, suited and unsuited full house, etc. Strategy for players is simple as it is advised to play/raise with every suited or connected two cards and all pairs. A progressive jackpot may apply for a suited 6-6-6-6+joker.

Blackjack 11

The object is to score a points total closest to eleven from a maximum of four cards. Blackjack in this case is 6-5 both suited and unsuited with unsuited paying 6 for 5 and suited paying 6-4, depending on the final math. Players place a wager and from the community deal of six cards, the first two cards will be the player's hand. Splits are not allowed except 6-6, and players receiving just one card on each. These will be 3rd and 4th cards from the deal. Depending on the final math, a player being dealt another six when splitting will either be a push or a bust.

Based on the first two cards, players may draw a maximum of two more card with again the 3rd and fourth cards from the deal as the additions to the player's hand. The dealer's hand will consist of the 5th and 6th cards with the dealer playing the 4th and 3rd. In effect, the six cards are dealt in sequence with the player's cards being from left to right and the dealer's cards from right to left.

If the math allows, a player scoring under from the first four cards may count as a push. A bonus payout for the players if the first four cards are four aces. A progressive jackpot may apply if the player and dealer tie on a points total of four (four aces) or a tie on eight (four deuces). In effect, a progressive jackpot will require six aces to be dealt or six deuces. The above may apply to suited or unsuited ties.

Pick Three

Pick Three allows players to pick three of the six cards possible from ace through to six that they predict will form part of the deal. The following are example payouts and are dependent on the final math: 4 from 6 pays 3/2; 5 from 6 pays 2/1; 6 from 6 pays 3/1. Higher odds will apply if any of the above form two pairs, three pairs, three of a kind of and X2 three of a kind.

Pick Two

The object if to pick two of the six cards a player predicts will form part of the deal. The more times those two cards appear on the deal, the higher the payout to the player. Example odds are as follows: Three cards on the deal pays 1/1; Four cards on the deal pays 2/1; Five cards on the deal pays 4/1; Six cards on the deal pays 10/1.

Prop Wagers, Option Bonus Wagers and Jackpots

The following optional wagers and progressive jackpots can apply to one specific game, a combination of games or all inclusive across the board. The following could be offered with either a five or six card community deal. The following examples, however, are all based on a six-card deal.

Hop Wagers

Suited Pairs, a variety of wagers can apply to suited pairs, such red sixes, black fives or black sixes and red fives; being dealt in any order of the deal or specific to each pair of cards, meaning three possible chances from the first two card, the 3rd and 4th cards or the fifth and sixth cards.

This wager can be expanded to include a paytable based on more than one deal, with different odds on offer depending on the number of suited pairs accumulated during the number of deals applied. For example, if the wager applies to five deals, there are thirty cards in total, meaning a possible 15 suited pairs would be the maximum and a maximum of three possible suited pairs with each deal. If three of the same suited are deals during one deal, it will only count as one suited pair.

Example Paytable for one unit: 12 suited pairs pays 100; 11 suited pairs pays 50; 10 suited pairs 35; 9 suited pairs 30; 8 suited pairs 20; 7 suited pairs 12; 6 suited pairs 10; 5 suited pairs 5; 4 suites 3.

A second paytable could apply for unsuited pairs but with reduced odds on offer. There is also the option to increase the number of deals for each wager, meaning that the odds or payouts will adjust accordingly. The more deals included in the wager, the less odds would apply.

Trio's Galore

This optional wager will also pay various odds for a number of trio's or three-of-a-kind dealt within a selected number of deals. For example, ten deals of six cards would allow for 20 trio's to be dealt.

A Trio paytable would therefore offer the following example odds. All payout apply to one unit: 13 Trio's 100; 12 Trio's 66; 11 Trio's 50; 10 Trio's 35; 9 Trio's 25; 8 Trio's 20; 7 Trio's 12; 6 Trio's 8; 5 Trio's 2.

A four-of-a-kind wager could also apply and pay different odds depending on the number of deals it takes to be dealt. Example Paytable based on one unit: 1 deal 50; 2 deals 35; 3 deals 30; 4 deals 20; 5 deals 10; 6 deals 5; 8 deals 3; 9 deals 2.

Flop A Flush

This paytable requires all six cards of the same suit to be dealt in on deal and the odds would be dependent on the number of deals before a flush is dealt. Example odds are to one unit. Flush in 1 deal pays 12; Flush in 2 deals 8; Flush in 3 deals 5; Flush in 4 deals 3; Flush in 5 deals 2; Flush in six deals 1.

Standard Deck

The same method can apply to dealing with a standard deck of 52 cards with the following games and may also include a combination of games from the custom deck. Apart from the community deal, player and or dealer may be dealt any number of cards that apply to specific games but utilize the community deal to create or complete each specific game. In blackjack for example, the player and dealer may be dealt one, two or more cards as a starting hand for blackjack.

In effect, there will be games in which both player and dealer will only create hands from the community and games in which the player and or dealer will be dealt a starting hand, irrespective of how many cards are dealt on each community deal. In some cases, player and dealer may share one or more cards from the community deal. The number of pauses during a hand may also vary depending on the games included in the system. The deal may also vary in terms of the sequence in which the community cards are revealed.

Blackjack

Players place a wager and the first two cards of the deal are the player's starting hand. Players may only split in instances when the can receive only on card on each split hand. The maximum number of cards both player's and deal can use from the community deal will be four.

Whereas the player's hand begin left to right, the dealer's hand will begin right to left, meaning that both player and dealer may share 3rd and 4th cards from the deal. Irrespective of the number of cards used by both player and dealer, it will always be in sequence beginning from left to right for the player and right to left for the dealer.

Baccarat

Players place a wager and will form their baccarat hand from the first three cards. The dealer will form a baccarat hand from the 4th, 5th and 6th cards.

One-Card Poker

In this version, there are thirteen wagering cards from deuce through an ace, with a deuce lowest and ace highest. Players may place a wager on one or more wagering cards. The odds will vary with Ace offering the shortest odds and deuce offering the highest odds. For example, an ace may offers 8/1 and a deuce 80/1. Each wagering cards represent all four suits.

From the community deal, four cards will be used along with the one wagering card to form the best five-card poker hand. For example, if the deal is ace, six, queen, five, four and king—the ace wagering card will be used to form a pair of aces. If the deal is ace, six, queen, four, four, king, then it will be the four that will be used to make three-of-a-kind.

In any deal when there are four cards of the same suit, the next highest card from the wagering cards will be used to form the best flush. For example, in ace is the highest card followed by a queen, then the King wagering card will determine the best hand. In instances when four cards of the same suit are also in sequence, for example, 4-5-6-7, the wagering card eight will be the winning card.

Craps

With using a standard 52 card deck, only cards from ace through to six from any one deal and do not carry forward to the next deal. If two card of six and under form part of the deal, then these two would count to ward any craps wager. If three cards under a six form part of the deal, then only the first two cards will count for craps.

When four such low cards form part of the deal, the first two will count towards craps wagers and the last two. If five cards of six and under are dealt, then only the first four cards count towards craps. With the first two such cards counting first and the following two counting next. If six such low cards are dealt, then there will be three craps wagers with the first two counting first, the second two counting next and the final two counting after that.

Flushes

A variety of wagers can be offered on how many cards form a flush from two to six as well how many sets of flushes from one or more deals. For example, on a single deal, players may wager on how many two-card, three, four card, five card or six card flush will be dealt. All odds will be determined by the final math.

The following are example odds and paytables: 3 card flush 1/1; 4 card flush 2/1; 5 card flush 5/1; 6 card flush 25/1; 3-card straight flush 12/1; 4-card straight flush 40/1; 5-card straight flush 100/1; 6 card straight flush Jackpot. A similar paytable may apply for straights of 3,4,5 or six cards and with a similar paytable.

Hi-Lo Twister

The game described above based on the custom deck can also apply to a standard deck with any card under eight needing a higher card to continue the sequence and any card over and 8 needing to go lower.

Points Poker

All cards from deuce up to and including ten count at face value with jack counting eleven, queens twelve, kings thirteen and aces fourteen, a wide variety of wagers can be offered based on the total value of the community board.

Two-Card War

Players place an ante and use the first two cards of the community in what will be a two card race against the dealer. Based on those two cards, players must decide to play by making a further wager or forfeit the ante. The dealer's hand, in this case, will be the last two cards of the community deal. The two races are between the first two cards and final two cards with the player's first race starting from the left (the first card of the deal) and the dealer's right (the last card dealt).

A bonus may be paid for a player winning both races with a pair. Depending on the final math, the dealer may win all ties. Player must win both races to win and lose both to lose the wager.

Pick a Card

Players can place a wager on any of the thirteen cards to form part of the deal. A bonus payout would apply if the card formed a pair, three-of-king or four-of a kind. The odds on all payouts will be determined by the final math.

Other

There are two decks of cards viable for this system. One is a standard deck of 52 cards. The second is a deck of dice whereas there are six cards in a set (from ace through to six), two colors and two suits and with 8 sets forming a deck of 48 cards.

A community board of multiple cards ranging from two to ten is dealt with all cards face down. In this example, the community deal will consist of six cards. These are split into two groups (A) and (B). The object is to offer a selection of popular and unique games, which will use the community deal to determine the outcome to all the games selected.

The six cards in this example are split into two groups of three with Group A forming the games from left to right from the community deal. Group B will form identical games from right to left. With the community deal determining the outcome to several games, it eradicates any trust issues when using the Random Number Generator (RNG) model. This is paramount in offering a wagering method in which player may wager Group A or Group B.

Before any of the six cards are revealed, both groups will offer identical games and odds minus any commission introduced. The odds for each game fluctuate as cards from both groups are revealed. The revealing of cards begins with the first card from left to right (Group A) is revealed, followed by the first card from right to left (Group B).

There would follow a pause for players to place further wagers with the new odds on display. The revealing of cards process continues with the next card from left to right to and the next card from right to left. After another pause for wagering, the final two cards are revealed and all outcomes to each game determined.

Players may wager on more than one game in the form of parlays, meaning doubles, trebles and accumulators. The community deal of six cards may be repeated numerous times. For example, if three games are offered for wagering, by having additional community deals, that number could be expanded to six, nine, twelve or more. In effect, the three games would be repeated on each community. This would allow several more wagering options for players wishing to place parlays.

Another unique feature is how the system and method allow for the odds to fluctuate but not just be the percentages of the potential outcomes, but fluctuate by the same means applied to horse racing through para mutual or tote. In effect, the odds may be determined more by how much is wagered on certain outcomes than the actual odd of the potential outcomes.

Although the system is similar to the exchange betting currently offered by Betfair, the three unique additional features of introducing multi-games, the impact on the RNG model and the options of parlays makes this application unique.

Electronics and Systems

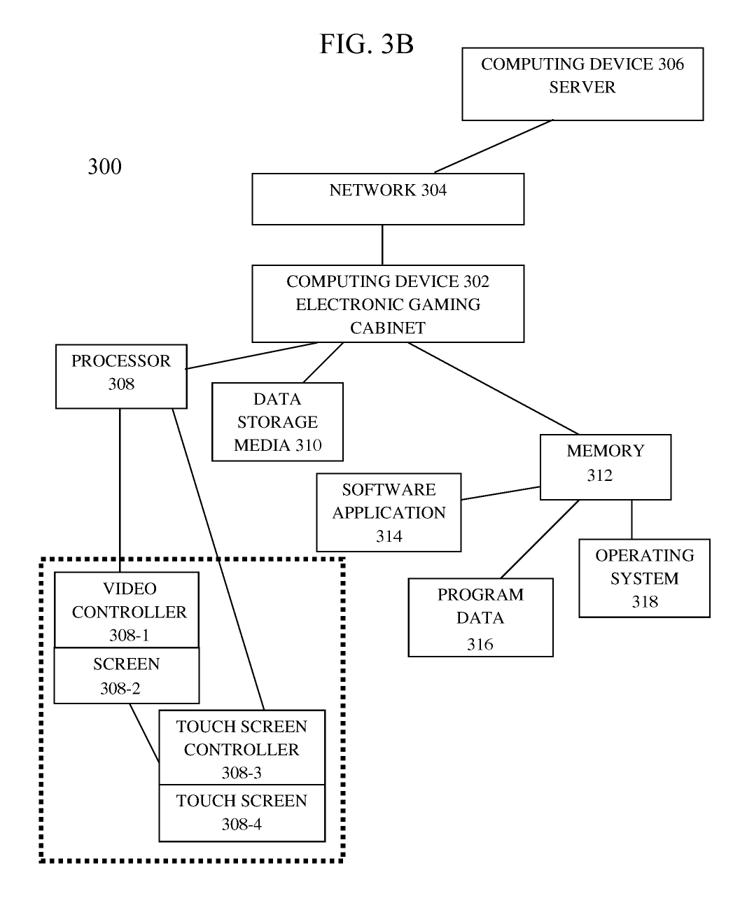

In some embodiments, the system described herein uses a computing system to carry out the various functions described herein. FIGS. 3A and 3B are schematic block diagrams of an example computing system 300. The example computing system 300 includes at least one computing device 302. In some embodiments the computing system 300 further includes a communication network 304 and one or more additional computing devices 306 (such as a server).

The computing device 302 can be, for example, located in a gaming establishment or can be a computing device 302 located in a user's home or office. In some embodiments, computing device 302 is a mobile device. The computing device 302 can be a stand-alone computing device or a networked computing device that communicates with one or more other computing devices 306 across a network 304. The additional computing device(s) 306 can be, for example, located remotely from the first computing device 302, but configured for data communication with the first computing device 302 across a network 304.

In some examples, as illustrated in FIGS. 3A and 3B, the computing devices 302 and 306 include at least one processor or processing unit 308 and system memory 312. The processor 308 is a device configured to process a set of instructions. In some embodiments, system memory 312 may be a component of processor 308; in other embodiments system memory 312 is separate from the processor 308. Depending on the exact configuration and type of computing device, the system memory 312 may be volatile (such as RAM), non-volatile (such as ROM, flash memory, etc.) or some combination of the two. System memory 312 typically includes an operating system 318 suitable for controlling the operation of the computing device 302, such as the WINDOWS® operating systems or the OS X operating system, or a server, such as Windows SharePoint Server, also from Microsoft Corporation, or such as a Mac Mini with OS X. The system memory 312 may also include one or more software applications 314 and may include program data 316.

The computing device 302 may have additional features or functionality. For example, the computing device 302 may also include additional data storage devices 310 (removable and/or non-removable) such as, for example, magnetic disks, optical disks, or tape. Computer storage media 310 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media 310 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 302. An example of computer storage media 310 is non-transitory media.

In some examples, one or more of the computing devices 302 or 306 can be located in a gaming cabinet or video poker terminal located in an establishment, such as a casino or bar. A schematic diagram of such a device is shown in FIG. 3B. The computing device 302 and 306 may be an electronic gaming machine with input device options including, but not limited to, a video controller 308-1, a screen 308-2, a touch screen controller 308-3, or a touch screen 308-4. In other examples, the computing device 302 can be a personal computing device that is networked to allow the user to play card games disclosed herein from a remote location, such as in a user's home or other location.

In some embodiments, the computing device 302 is a smart phone, tablet, laptop computer, personal digital assistant, or other mobile device. In some embodiments, system operations and functions are stored as data instructions for a smart phone application. A network 304 facilitates communication between the computing device 302 and one or more servers, such as an additional computing device 306, that hosts the system. The network 304 may be a wide variety of different types of electronic communication networks. For example, the network 304 may be a wide-area network, such as the Internet, a local-area network, a metropolitan-area network, or another type of electronic communication network. The network 304 may include wired and/or wireless data links. A variety of communications protocols may be used in the network 304 including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 306 is a Web server. In this example, the first computing device 302 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor 308 of the one or more computing devices 302 or 306, the instructions cause the processor 308 to perform one or more of the operations or methods disclosed herein. Examples of operations include the operations of game play and enforcement of one or more rules of the game

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A deck of 48 cards comprised of:
eights sets of ace through six, wherein:
a first four sets of ace through six display a first suit;
a second four sets of ace through six display a second suit;
a first two of the first four sets and a first two of the second four sets of ace through six display red circles; and
a second two of the first four sets and a second two of the second four sets of ace through six display black squares.

2. A method of playing a card game with players and dealer in a computing system comprising at least one server to host the card game and at least one computing device communicably coupled to the at least one server through a communication network, the method comprising:
using a card deck of 48 cards, wherein the card deck is comprised of two suits and 8 sets of six cards that are numbered Ace, two, thee, four, five, and six;
dealing at least two community cards, wherein a player's cards are utilized from at least a first two cards dealt and a dealer's cards are utilized from at least a last two cards dealt; and
determining whether a player has won through the at least one server.

3. The method of claim 2, wherein five total community cards are dealt, the method further comprising:
allowing the player to choose two of the first three cards dealt to create a score of nine or less;
allowing the dealer to choose two of the last three cards dealt to create a score of nine or less;
determining whether the player has won through the at least one server by understanding whether the player or dealer is closer to a score of nine.

4. The method of claim 2, wherein at least five total community cards are dealt, the method further comprising:
accepting a first round of betting before any cards are dealt;
dealing three community cards;
accepting a decision from the player, wherein the decision is to forfeit or make a second wager;
dealing at least two additional community cards;
assigning the first three cards to the player;
assigning the last three cards to the dealer;
determining whether the player has won through the at least one server by understanding which player has the best three-card poker hand.

5. The method of claim 2, wherein at least five total community cards are dealt, the method further comprising:
accepting a first round of betting before any cards are dealt;
dealing a first, a second, a third, a fourth, a fifth, and a sixth community card;
assigning the first and the second community cards to the player;
accepting a first decision from the player, wherein the first decision is whether to draw the third community card;
accepting a second decision from the player, wherein the second decision is whether to draw the fourth community card;
assigning the fifth and sixth community cards to the dealer;
allowing the dealer to play the fourth community card;
allowing the dealer to play the third community card;
determining whether the player has won through the at least one server by understanding whether the player or dealer is closer to a score of eleven.

6. The method of claim 5, wherein six cards are dealt, the method further comprising accepting a prediction from the player, wherein the prediction is which two of the six cards possible will be dealt, the six cards being selected from the group consisting of: ace, two, three, four, five, and six.

7. The method of claim 5, wherein six cards are dealt, the method further comprising accepting a prediction from the player, wherein the prediction is which three of the six cards possible will be dealt, the six cards being selected from the group consisting of: ace, two, three, four, five, and six.

8. The method of claim 2, wherein at least five total community cards are dealt, the method further comprising:
accepting a first round of betting before any cards are dealt;
dealing a first community card;
accepting a first decision from the player, wherein the first decision is whether a second community card will have a higher or lower value than the first community card;
dealing the second community card;
determining a first outcome, wherein the first outcome is whether the second community card is higher or lower than the first community card;
determining if the player has lost, wherein the player has lost if the first decision of the player does not match the first outcome;
accepting a second decision from the player, wherein the second decision is whether a third community card will have a higher or lower value than the second community card;
dealing the third community card;
determining a second outcome, wherein the second outcome is whether the third community card is higher or lower than the second community card;
determining if the player has lost, wherein the player has lost if the second decision of the player does not match the second outcome;
accepting a third decision from the player, wherein the third decision is whether a fourth community card will have a higher or lower value than the third community card;
dealing the fourth community card;
determining a third outcome, wherein the third outcome is whether the fourth community card is higher or lower than the third community card;
determining if the player has lost, wherein the player has lost if the third decision of the player does not match the third outcome;
accepting a fourth decision from the player, wherein the fourth decision is whether a fifth community card will have a higher or lower value than the fourth community card;
dealing the fifth community card;
determining a fourth outcome, wherein the fourth outcome is whether the fifth community card is higher or lower than the fourth community card;
determining if the player has lost, wherein the player has lost if the fourth decision of the player does not match the fourth outcome.

9. A method of playing a card game with players and dealer in a computing system comprising at least one server to host the card game and at least one computing device communicably coupled to the at least one server through a communication network, the method comprising:
using a standard card deck of 52 cards, wherein the card deck is comprised of four suits and each suit is numbered ace, two, thee, four, five, six, seven, eight, nine, ten, jack, queen, king;
dealing at least two community cards, wherein a player's cards are utilized from at least a first two cards dealt and a dealer's cards are utilized from at least a last two cards dealt; and
determining whether a player has won through the at least one server.

10. The method of claim 9, wherein five total community cards are dealt, the method further comprising:
allowing the player to choose two of the first three cards dealt to create a score of nine or less;
allowing the dealer to choose two of the last three cards dealt to create a score of nine or less;
determining whether the player has won through the at least one server by understanding whether the player or dealer is closer to a score of nine.

11. The method of claim 9, wherein at least five total community cards are dealt, the method further comprising:
accepting a first round of betting before any cards are dealt;
dealing three community cards;
accepting a decision from the player, wherein the decision is to forfeit or make a second wager;
dealing at least two additional community cards;
assigning the first three cards to the player;
assigning the last three cards to the dealer;
determining whether the player has won through the at least one server by understanding which player has the best three-card poker hand.

12. The method of claim 9, wherein at least five total community cards are dealt, the method further comprising:
accepting a first round of betting before any cards are dealt;
dealing a first, a second, a third, a fourth, a fifth, and a sixth community card;
assigning the first and the second community cards to the player;
accepting a first decision from the player, wherein the first decision is whether to draw the third community card;
accepting a second decision from the player, wherein the second decision is whether to draw the fourth community card;
assigning the fifth and sixth community cards to the dealer;
allowing the dealer to play the fourth community card;
allowing the dealer to play the third community card;
determining whether the player has won through the at least one server by understanding whether the player or dealer is closer to a score of eleven.

13. The method of claim 12, wherein six cards are dealt, the method further comprising accepting a prediction from the player, wherein the prediction is which two of the six cards possible will be dealt, the six cards being selected from the group consisting of: ace, two, three, four, five, and six.

14. The method of claim 12, wherein six cards are dealt, the method further comprising accepting a prediction from the player, wherein the prediction is which three of the six cards possible will be dealt, the six cards being selected from the group consisting of: ace, two, three, four, five, and six.

15. The method of claim 9, wherein at least five total community cards are dealt, the method further comprising:
accepting a first round of betting before any cards are dealt;
dealing a first community card;
accepting a first decision from the player, wherein the first decision is whether a second community card will have a higher or lower value than the first community card;
dealing the second community card;
determining a first outcome, wherein the first outcome is whether the second community card is higher or lower than the first community card;
determining if the player has lost, wherein the player has lost if the first decision of the player does not match the first outcome;
accepting a second decision from the player, wherein the second decision is whether a third community card will have a higher or lower value than the second community card;
dealing the third community card;
determining a second outcome, wherein the second outcome is whether the third community card is higher or lower than the second community card;
determining if the player has lost, wherein the player has lost if the second decision of the player does not match the second outcome;
accepting a third decision from the player, wherein the third decision is whether a fourth community card will have a higher or lower value than the third community card;
dealing the fourth community card;
determining a third outcome, wherein the third outcome is whether the fourth community card is higher or lower than the third community card;
determining if the player has lost, wherein the player has lost if the third decision of the player does not match the third outcome;
accepting a fourth decision from the player, wherein the fourth decision is whether a fifth community card will have a higher or lower value than the fourth community card;
dealing the fifth community card;
determining a fourth outcome, wherein the fourth outcome is whether the fifth community card is higher or lower than the fourth community card;
determining if the player has lost, wherein the player has lost if the fourth decision of the player does not match the fourth outcome.
